(19) United States
(12) Patent Application Publication
(10) Pub. No.: US 2025/0319892 A1
(43) Pub. Date: Oct. 16, 2025

(54) LAUNCH CONTROL INTERFACE AND METHOD

(71) Applicant: Rivian IP Holdings, LLC, Irvine, CA (US)

(72) Inventors: Erik Robert GLASER, San Mateo, CA (US); Paul Michael PRAX, II, Mountain View, CA (US); Britt Singh MIURA, Menlo Park, CA (US); Ian James DELANEY, Laguna Niguel, CA (US); Vivek Narsimhan SURYANARAYANAN, Irvine, CA (US)

(21) Appl. No.: 19/177,370

(22) Filed: Apr. 11, 2025

Related U.S. Application Data
(60) Provisional application No. 63/633,627, filed on Apr. 12, 2024.

(51) Int. Cl. B60W 50/08; B60W 10/08; B60W 10/26; B60W 50/14

(52) U.S. Cl. CPC B60W 50/085; B60W 10/08; B60W 10/26; B60W 50/14; B60W 2050/146; B60W 2540/10; B60W 2540/12; B60W 2540/18

(57) ABSTRACT

A controller of a vehicle presents interfaces enabling selection of launch control and indicating states of driver-controllable components (steering wheel, pedals) to enable the driver to configure the driver-controllable components suitable for performing a launch. Following selection of launch control and during verification of the driver-controllable components, components of the vehicle are configured in preparation for launch, such as drive units, battery, and/or suspension. A countdown may be displayed on a display device and a reaction time of the driver measured relative thereto. Data may be collected during a launch and subsequent run and be displayed during the run or superimposed on video data captured during a run.

### INTRODUCTION

This application claims the benefit of U.S. Provisional Application Ser. No. 63/633,627 filed Apr. 12, 2024, and entitled LAUNCH CONTROL INTERFACE AND METHOD

### INTRODUCTION

The present disclosure relates to an interface for invoking launch control of a vehicle.

### SUMMARY

The present disclosure describes an approach for invoking launch control of a vehicle and displaying data captured during a launch. In one aspect, a vehicle includes a chassis, a plurality of suspensions mounted to the chassis, a plurality of wheels mounted to the plurality of suspensions, a battery mounted to the chassis, and one or more drive units, each drive unit configured to drive one or more of the plurality of wheels using drive current supplied by the battery. The vehicle further includes a display device and a controller coupled to the battery, the one or more drive units, and the display device. The controller is configured to receive one or more inputs instructing a transition to a launch mode. In response to the one or more inputs, the controller invokes transitioning of one or more components of the vehicle to enable a launch of the vehicle, the one or more components including at least one of the battery, the one or more drive units, or the plurality of suspensions; provides an output on the display device, the output graphically representing a state of a driver-controllable component of the vehicle; and enables launching of the vehicle according to the launch mode in response to a state of the driver- controllable component being in a predefined configuration and completion of the transitioning of the one or more components.

### BRIEF DESCRIPTION OF THE DRAWINGS

FIG. 1A illustrates an example vehicle that may be operated in accordance with certain embodiments.

FIG. 1B illustrates a chassis of a vehicle having multiple drive units that may be operated in accordance with certain embodiments.

FIGS. 2A and 2B are schematic block diagrams of components for operating the vehicle in accordance with certain embodiments.

FIG. 3 is schematic block diagram illustrating power electronics of a vehicle in accordance with certain embodiments.

FIG. 4 is a process flow diagram of a method for invoking and implementing launch control in accordance with certain embodiments.

FIGS. 5A to 5C are timing diagrams of a method for invoking and implementing launch control in accordance with certain embodiments.

FIGS. 6 through 41 are example interfaces for invoking launch control and displaying the results of a launch in accordance with certain embodiments.

### DETAILED DESCRIPTION

A controller receives instructions to enter a launch mode and displays interface elements guiding a driver to prepare for the launch mode by graphically showing states of driver-controllable components such as a steering wheel, brake pedal and accelerator pedal. Upon receiving the instruction, the controller further begins transitioning components of vehicle in preparation for launch. Video and data are collected during the launch and a subsequent run and are displayed on a display device of the vehicle.

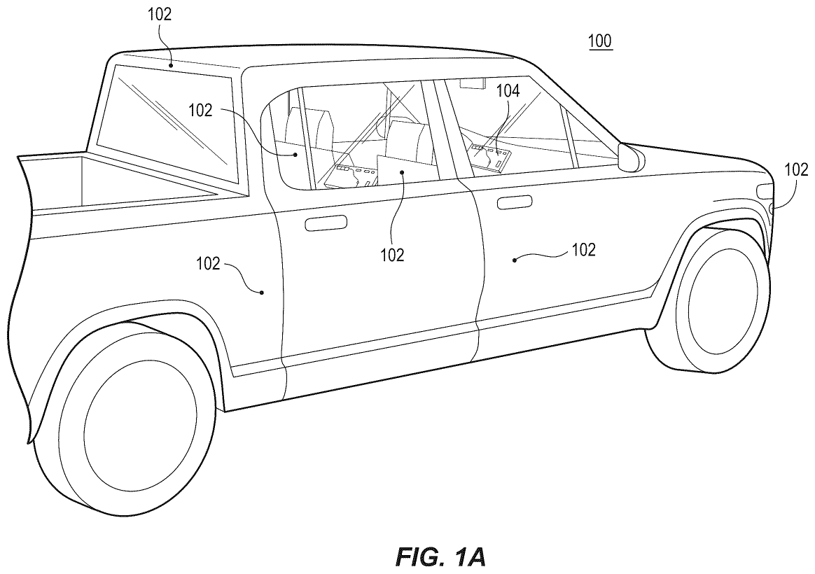

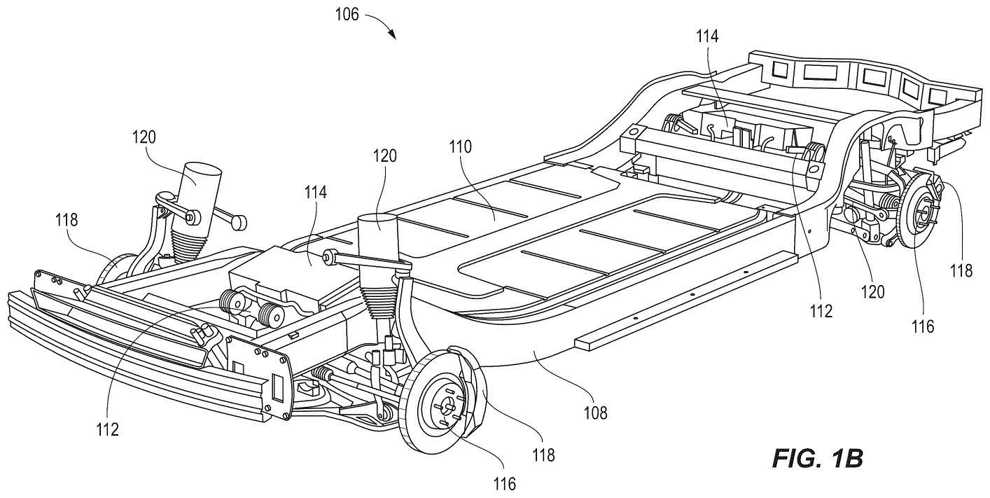

FIG. 1A illustrates an example vehicle 100 in which the approach described herein may be implemented. As seen in FIG. 1A, the vehicle 100 has multiple exterior cameras 102 and one or more front displays 104. Each of these exterior cameras 102 may capture a particular view or perspective on the outside of the vehicle 100. The images or videos captured by the exterior cameras 102 may then be presented on one or more displays in the vehicle 100, such as the one or more front displays 104, for viewing by a driver. The vehicle includes a plurality of wheels 105, such as four. At least two of the plurality of wheels 105, such as the front two are steered road wheels that can change angle responsive to changes in angle of a steering wheel or other steering handle, e.g., yoke, lever, etc.

Referring to FIG. 1B, the vehicle 100 may include a chassis 106 including a frame 108 providing a primary structural member of the vehicle 100. The frame 108 may be formed of one or more beams or other structural members or may be integrated with the body of the vehicle (i.e., unibody construction).

In embodiments where the vehicle 100 is a battery electric vehicle (BEV) or possibly a hybrid vehicle, a large battery 110 is mounted to the chassis 106 and may occupy a substantial (e.g., at least 80 percent) of an area within the frame 108. For example, the battery 110 may store from 100 to 200 kilowatt hours (kWh). The battery 110 may be a lithium-ion battery or other type of rechargeable battery. The battery may be substantially planar in shape.

Power from the battery 110 may be supplied to one or more drive units 112. Each drive unit 112 may be formed of an electric motor and possibly a gear train providing a gear reduction. In some embodiments, there is a single drive unit 112 driving either the front wheels 105 or the rear wheels 105 of the vehicle 100. In another embodiment, there are two drive units 112, each driving either the front wheels 105 or the rear wheels 105 of the vehicle 100. In yet another embodiment, there are four drive units 112, each drive unit 112 driving one of four wheels 105 of the vehicle 100.

Power from the battery 110 may be supplied to the drive units 112 by one or more power modules 114, such as power electronics for each drive unit 112 or pair of drive units 112. The power module 114 may include inverters configured to convert direct current (DC) from the battery 110 into alternating current (AC) supplied to the motors of the drive units 112. The power module 114 further facilitates operation of the motors of the drive units 112 as generators to provide regenerative braking. The power module 114 further facilitates the transfer of regenerative current to the battery 110.

The drive units 112 are coupled to two or more hubs 116 to which wheels 105 may mount. Each hub 116 includes a corresponding brake 118, such as the illustrated disc brakes. Each hub 116 is further coupled to the frame 108 by a suspension 120. The suspension 120 may include metal or pneumatic springs for absorbing impacts. The suspension 120 may be implemented as a pneumatic or hydraulic suspension capable of adjusting a ride height of the chassis 106 relative to a support surface. The suspension 120 may include a damper with the properties of the damper being either fixed or adjustable electronically.

In the embodiment of FIG. 1B and in the discussion below, the vehicle 100 is a battery electric vehicle. However, a hybrid-electric vehicle may also benefit from the approach described herein.

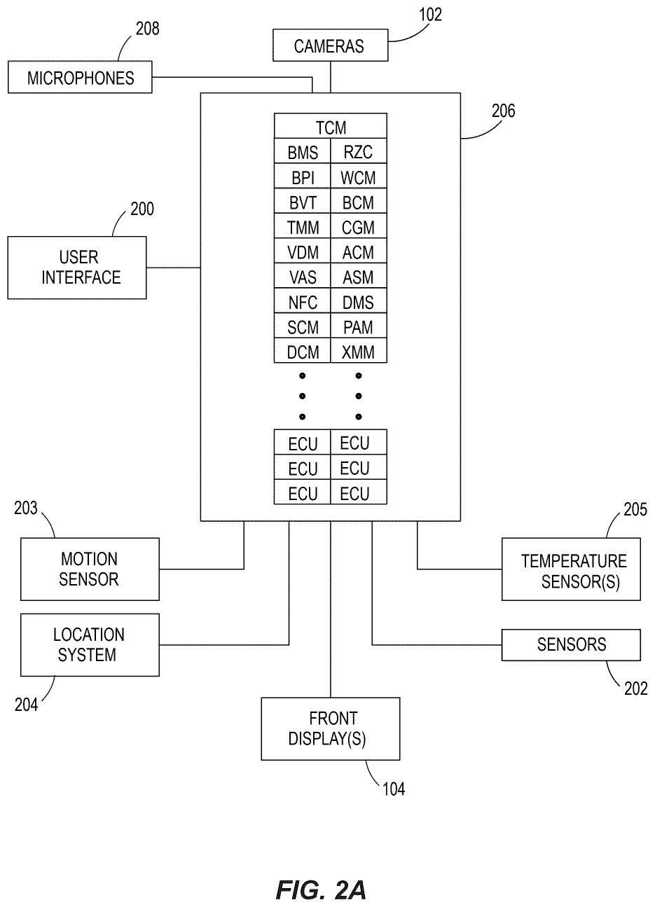

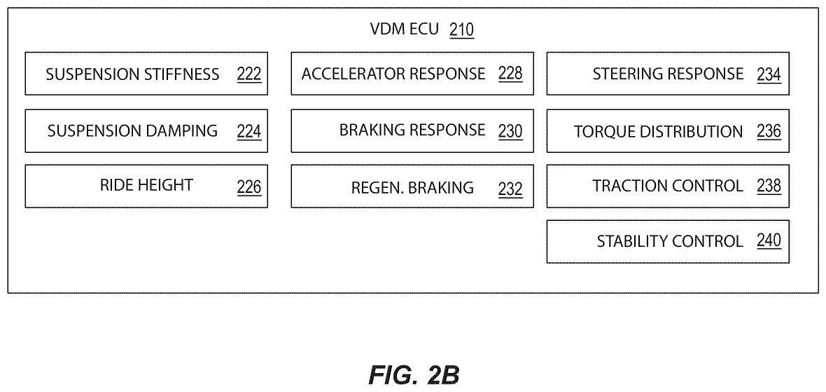

FIG. 2A illustrates example components of the vehicle 100 of FIG. 1A. As seen in FIG. 2A, the vehicle 100 includes the cameras 102, the one or more front displays 104, a user interface 200, one or more sensors 202, a motion sensor 204, and a location system 206. The one or more sensors 202 may include ultrasonic sensors, radio detection and ranging (RADAR) sensors, light detection and ranging (LIDAR) sensors, or other types of sensors. The location system 206 may be implemented as a global positioning system (GPS) receiver. The user interface 200 allows a user, such as a driver or passenger in the vehicle 100, to provide input.

The components of the vehicle 100 may include one or more temperature sensors 205. The temperature sensors 205 may include sensors configured to sense an ambient air temperature, temperature of the battery 110, temperature of power module 114, temperature of each drive unit 112 and/or each motor of each drive unit 112, temperature of coolant fluid entering or leaving a coolant system, temperature of oil within a drive unit 112, or the temperature of any other component of the vehicle 100. The temperature sensors 205 may include a temperature sensor directly mounted to a microprocessor of the power module 114.

A control system 214 executes instructions to perform at least some of the actions or functions of the vehicle 100. For example, as shown in FIG. 2, the control system 214 may include one or more electronic control units (ECUs) configured to perform at least some of the actions or functions of the vehicle 100, including the functions described hereinbelow. In certain embodiments, each of the ECUs is dedicated to a specific set of functions.

Certain features of the embodiments described herein may be controlled by a Telematics Control Module (TCM) ECU. The TCM ECU may provide a wireless vehicle communication gateway to support functionality such as, by way of example and not limitation, over-the-air (OTA) software updates, communication between the vehicle and the internet, communication between the vehicle and a computing device, in-vehicle navigation, vehicle-to-vehicle communication, communication between the vehicle and landscape features (e.g., automated toll road sensors, automated toll gates, power dispensers at charging stations), or automated calling functionality.

Certain features of the embodiments described herein may be controlled by a Central Gateway Module (CGM) ECU. The CGM ECU may serve as the vehicle's communications hub that connects and transfer data to and from the various ECUs, sensors, cameras, microphones, motors, displays, and other vehicle components. The CGM ECU may include a network switch that provides connectivity through Controller Area Network (CAN) ports, Local Interconnect Network (LIN) ports, and Ethernet ports. The CGM ECU may also serve as the master control over the different vehicle modes (e.g., road driving mode, parked mode, off- roading mode, tow mode, camping mode), and thereby control certain vehicle components related to placing the vehicle in one of the vehicle modes.

In various embodiments, the CGM ECU collects sensor signals from one or more sensors of vehicle 100. For example, the CGM ECU may collect data from cameras 102, sensors 202, motion sensor 204, location system 206, and temperature sensors 205. The sensor signals collected by the CGM ECU are then communicated to the appropriate ECUs for processing.

The control system 214 may also include one or more additional ECUs, such as, by way of example and not limitation: a Vehicle Dynamics Module (VDM) ECU, an Experience Management Module (XMM) ECU, a Vehicle Access System (VAS) ECU, a Near-Field Communication (NFC) ECU, a Body Control Module (BCM) ECU, a Seat Control Module (SCM) ECU, a Door Control Module (DCM) ECU, a Rear Zone Control (RZC) ECU, an Autonomy Control Module (ACM) ECU, an Autonomous Safety Module (ASM) ECU, a Driver Monitoring System (DMS) ECU, and/or a Winch Control Module (WCM) ECU.

If vehicle 100 is an electric vehicle, one or more ECUs may provide functionality related to the battery pack of the vehicle, such as a Battery Management System (BMS) ECU, a Battery Power Isolation (BPI) ECU, a Balancing Voltage Temperature (BVT) ECU, and/or a Thermal Management Module (TMM) ECU. In various embodiments, the XMM ECU transmits data to the TCM ECU (e.g., via Ethernet, etc.). Additionally or alternatively, the XMM ECU may transmit other data (e.g., sound data from microphones 208, etc.) to the TCM ECU.

Referring to FIG. 2B, a VDM ECU of the control system 206 may be configured as the illustrated VDM ECU 210. The VDM ECU 210 is configured to control driving characteristics of the vehicle 100. For example, the VDM ECU 210 may be configured with some or all of the illustrated attributes that may be set to have one of a discrete set of values or a range of values. A drive mode may be defined as including a collection of values for the attributes of the VDM ECU 210 defined by default and/or by a user for that drive mode. The VDM ECU 210 will then electronically configure the vehicle 100 according to the values for the attributes in order to implement a given drive mode. The examples below are described with reference to the attributes of the VDM ECU 210 with the understanding that the attributes defining the functionality of other components or functionality of the vehicle 100 may also have different values for different drive modes in the same manner.

The attributes may include attributes of the suspensions 120, such as suspension stiffness 222, suspension damping 224, and ride height 226. The values for these attributes may be the same for all the suspensions 120 or may be different, such as different for front and rear suspensions 120. The values for some attributes may be constrained to be the same for all suspensions 120, such as ride height.

The attributes may include an accelerator response 228. The accelerator response 228 defines the desired acceleration (positive or negative), change in torque output by one or more motors, change in current supplied to one or more motors, or some other metric. The accelerator response may be a function of a position, or change in position, of an accelerator pedal of the vehicle 100. The accelerator response 228 may be a function of the current velocity of the vehicle. The accelerator response 228 may include a discrete set of accelerator responses, such as an accelerator response for each drive mode and/or for groups of two or more drive modes.

The attributes may include a braking response 230. The braking response 230 defines a desired deceleration, braking fluid pressure, or other metric of braking performance to be achieved for a given position, or change in position, of a brake pedal of the vehicle 100. The braking response 230 may be a function of the current velocity of the vehicle. The braking response 230 may include a discrete set of braking responses, such as a braking response for each drive mode and/or for groups of two or more drive modes.

The attributes may include a regenerative braking behavior 232. The regenerative braking behavior 232 defines an amount of power generation to be performed in response to releasing of the accelerator pedal, depressing of the brake pedal, or other event. The regenerative braking behavior 232 may be a function of the velocity of the vehicle 100. The regenerative braking behavior 232 may include a discrete set of regenerative braking behaviors, such as a regenerative braking behavior for each drive mode and/or for groups of two or more drive modes.

The attributes may include a steering response 234. The steering response 234 defines an angle or change in angle of two or four wheels 105 of the vehicle 100 for a given angle or change in angle of a steering wheel, yoke, lever, or other interface. The steering response 234 may be a function of the velocity of the vehicle 100. The steering response 234 may include a discrete set of steering responses, such as a steering response for each drive mode and/or for groups of two or more drive modes.

The attributes may include a torque distribution 236. The torque distribution 236 may define a ratio of torque applied to the front wheels 105 relative to the torque applied to the rear wheels 105. For example, in an energy saving mode, the drive unit 112 driving the front wheels 105 may contribute zero torque or less than 10 percent of the torque supplied by the rear wheels 105, or vice versa. The torque distribution 236 may include a discrete set of torque distributions, such as a torque distribution for each drive mode and/or for groups of two or more drive modes.

The attributes may include traction control behavior 238. The traction control behavior 238 defines the function of a traction control system configured to prevent slipping of the wheels 105 of the vehicle 100. The traction control behavior 238 may define how aggressively this function is performed or whether the function of the traction control system is disabled. The traction control behavior 238 may include a discrete set of traction control behaviors, such as a traction control behavior for each drive mode and/or for groups of two or more drive modes.

The attributes may include stability control behavior 240. The stability control behavior 240 defines the function of a stability control system configured to prevent the vehicle 100 from achieving states where rollover is likely. The stability control system may do so by overriding steering and accelerator pedal inputs of a driver in response to detected longitudinal acceleration, lateral acceleration, or rotational acceleration in some or all of the pitch, yaw, and roll directions. The stability control behavior 240 may define how aggressively this function is performed or whether the function of the stability control system is disabled. The stability control behavior 240 may include a discrete set of stability control behaviors, such as a stability control behavior for each drive mode and/or for groups of two or more drive modes.

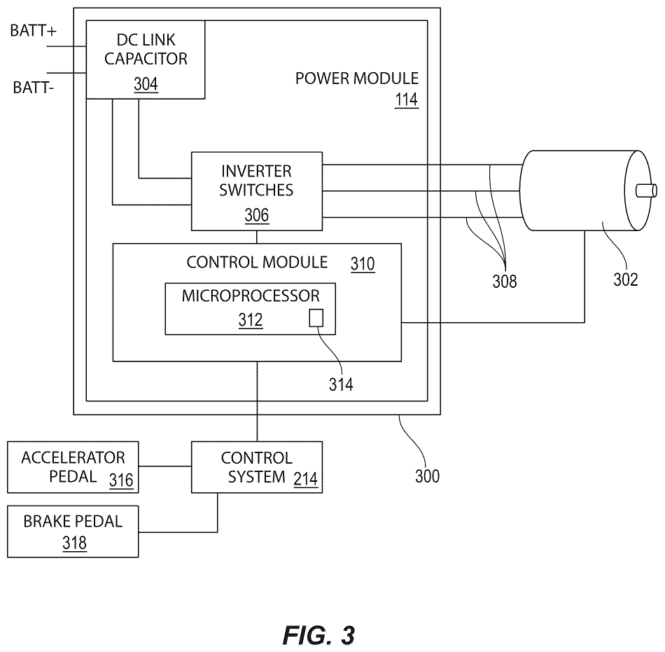

Referring to FIG. 3, the power module 114 may be contained within a housing 300, such as a housing made of aluminum or steel. The power module 114 may include a plurality of components configured to convert direct current (DC) from the battery 110 into alternating current (AC), such as three-phase AC, supplied to one or more motors 302 of the drive unit 112 including the power module 114.

The power module 114 may receive power from the battery 110 by way of a DC link capacitor 304 that is coupled to the positive and negative terminals (Batt+, Batt−) of the battery 110 and functions to smooth current received from the battery 110 as part of the process by which the direct current from the battery 110 is converted to an approximately sinusoidal alternating current. The DC link capacitor 304 may further function to dampen any voltage spikes. The DC link capacitor 304 may be within the housing 300 or external to the housing 300.

The power module 114 may include inverter switches 306 coupled to the outputs of the DC link capacitor 304. The inverter switches 306 may include a plurality of switches that are selectively opened and closed to cause transmission of current to the outputs of the power module 114 at an appropriate frequency for driving the one or more motors 302. For example, the inverter switches 306 may output three-phase current over lines 308 connecting the inverter switches 306 to the motor 302. The opening and closing of the inverter switches 306 may be controlled by a control module 310. The control module 310 may include a printed circuit board with various electronic components configured to generate the control signals for the inverter switches 306. In some embodiments, the power module 114 drives two drive units 112 and includes separate printed circuit boards for supplying current to the motors 302 of the separate drive units.

The control module 310 may further include a microprocessor 312 programmed to control operation of the control module 310 and therefore the inverter switches 306. The microprocessor 312 may be embodied as a silicon chip mounted to the printed circuit board of the control module 310. The microprocessor 312 may include a temperature sensor 314 mounted directly thereto.

The control module 310 may be coupled to the control system 214 and implement instructions from the control system 214 to control current supplied to the motor 302 and to cause the motor 302 to produce regenerative current. The control system 214 may generate such instructions as part of an automated driving algorithm (e.g., automatic cruise control), safety algorithm (e.g., traction control, stability control, automated emergency braking), or in response to inputs from a driver by way of an accelerator pedal 316 and/or brake pedal 318.

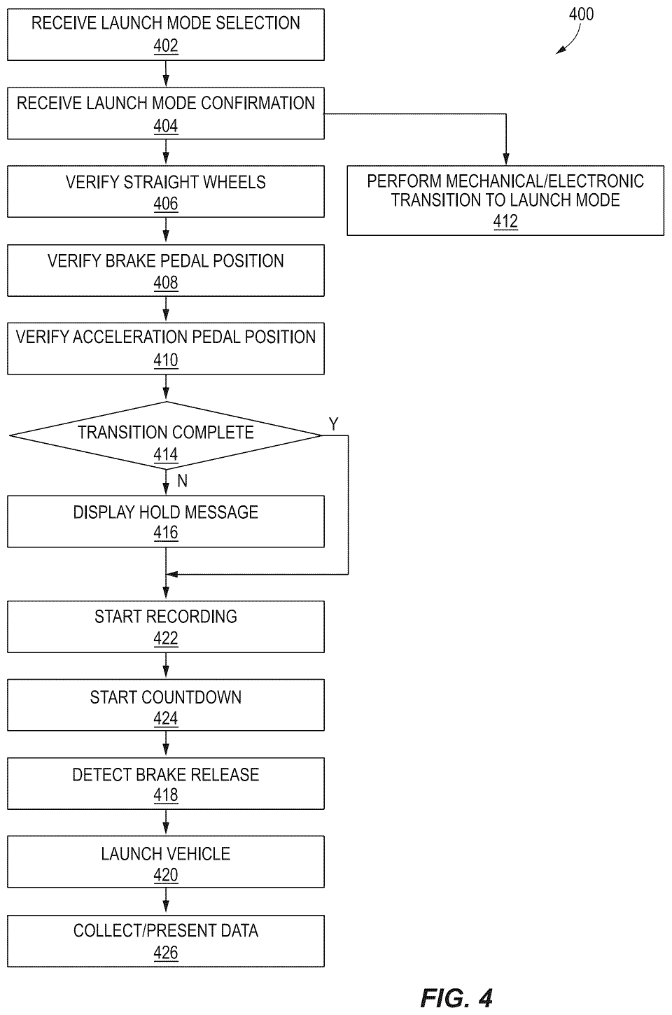

Referring to FIG. 4, the control system 214 may implement a plurality of drive modes, one of which may be a launch mode. The launch mode configures the vehicle to achieve maximum acceleration for a short distance (e.g., a quarter mile) or a short time (e.g., until a maximum speed is reached, such as less than a minute). The launch mode may therefore include at least two types of modifications: (a) modifications to tune the vehicle in order to achieve high acceleration (e.g., higher than during normal operation) and (b) modifications to suspend limitations that are imposed for longevity of components during long-term normal operation. The illustrated method 400 is described in the context of a battery electric vehicle. However, launch control for an internal combustion engine vehicle, hybrid-electric vehicle, or any other type of vehicle may benefit from the interfaces and functions described herein.

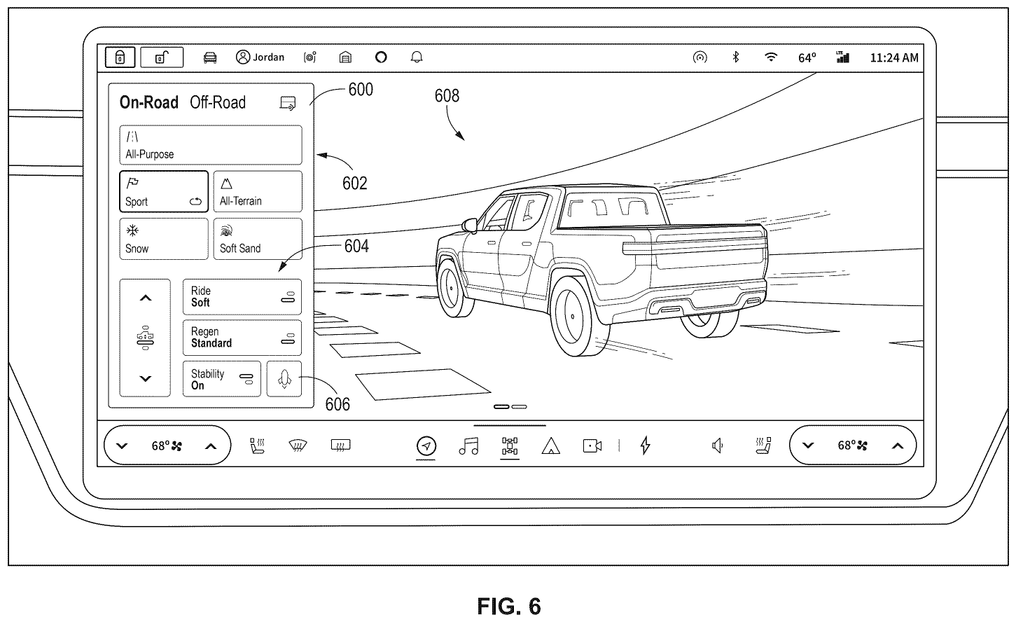

The method 400 may include receiving, at step 402, selection of launch mode. Step 402 may include receiving selection of launch mode from among a plurality of available drive modes. The selection may be received through an interface on a front display 104 or other input device. Step 404 may include receiving, at step 404, confirmation of selection of launch mode. Because of the high acceleration and speed of a launch, step 404 may be performed to prevent inadvertent selection of launch control. Step 404 may therefore include one or more additional selections or gestures received through a front display 104, button presses, voice commands, or other input in addition to the input received at step 402 (see FIGS. 6-10 and corresponding description, below).

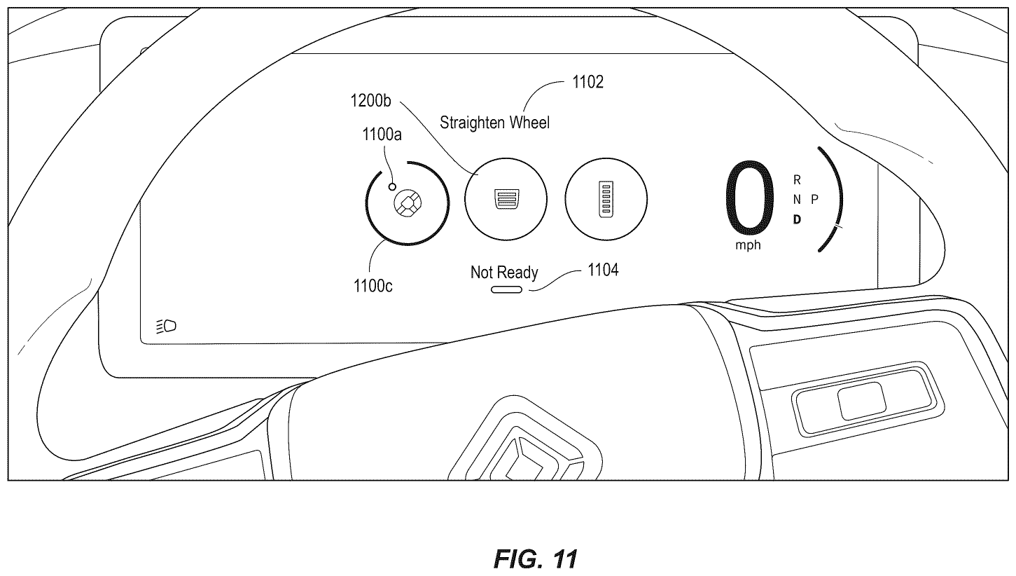

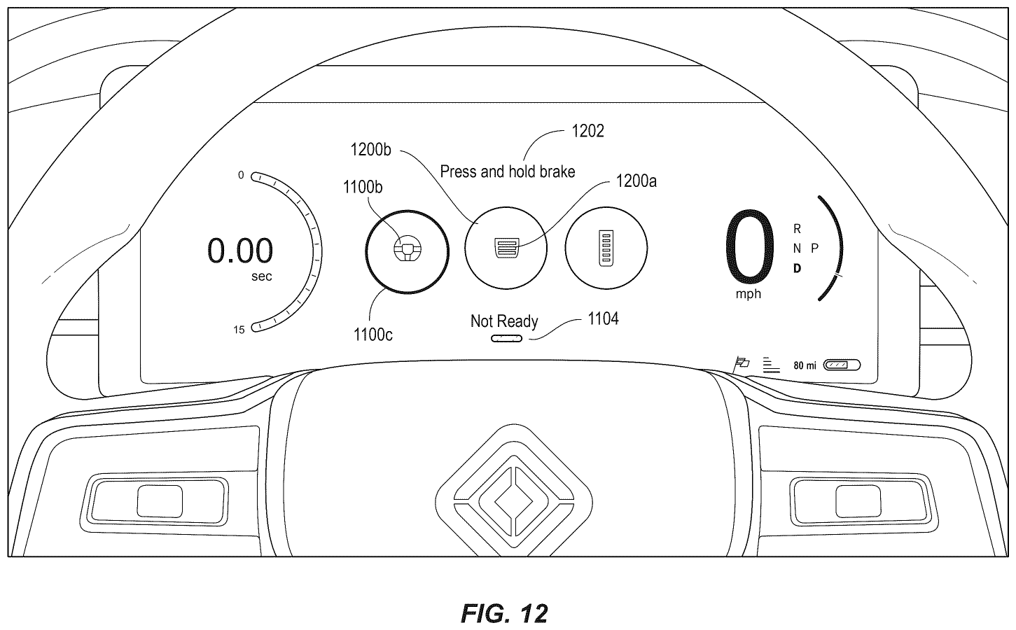

The method 400 may include verifying, at step 406, that road wheels 105 of the vehicle 100 are straight, e.g., within a pre-defined tolerance of straight, such as less than two degrees, less than one degree, or less than 0.5 degrees. Step 406 may be accompanied by display of an interface on a front display 104 and display of an indication when the wheels 105 are oriented correctly (see FIGS. 11 and 12 and corresponding description).

The method 400 may include verifying, at step 408, that the brake pedal 318 is depressed sufficiently, such to at least a predetermined brake pedal position. Step 408 may be accompanied by display of an interface on a front display 104 and display of an indication when the wheels 105 are oriented correctly (see FIG. 12-14 and corresponding description).

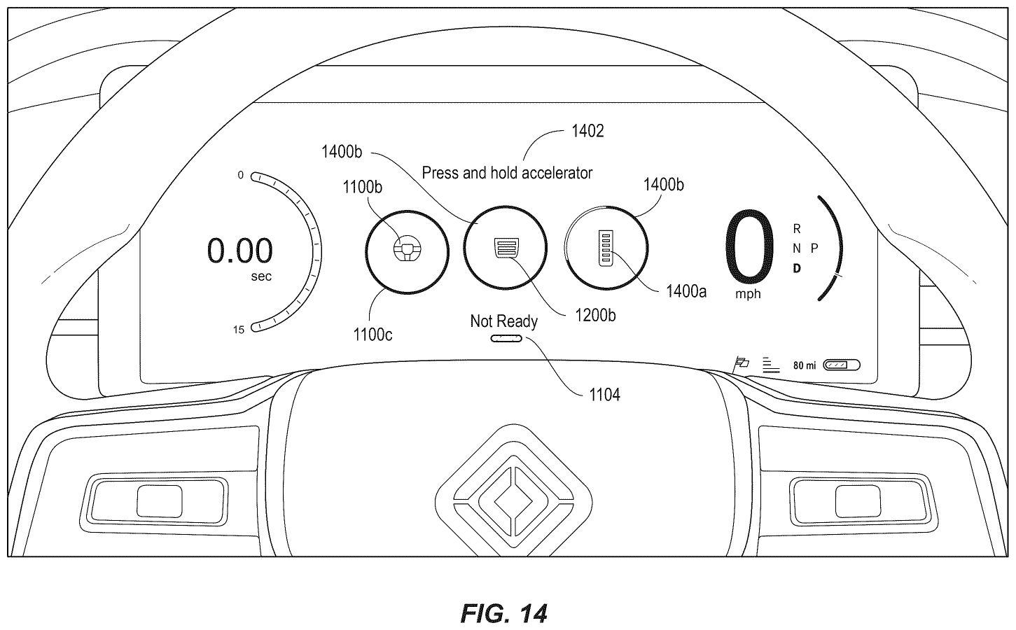

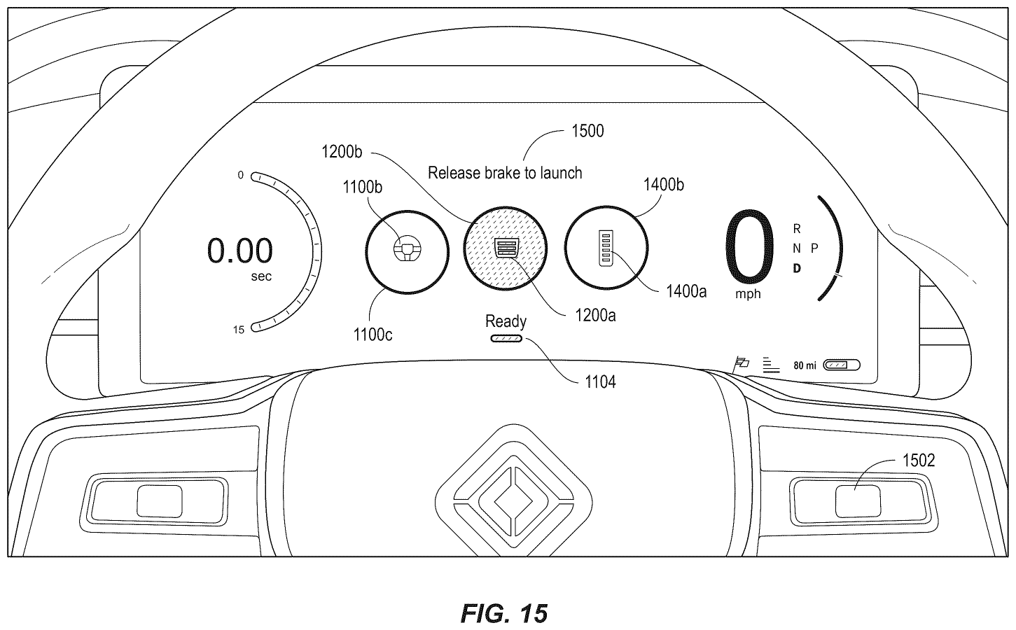

The method 400 may include verifying, at step 410, that the brake pedal 318 is depressed sufficiently, such as to at least a predetermined accelerator pedal position. Step 410 may be accompanied by display of an interface on a front display 104 and display of an indication when the wheels 105 are oriented correctly (see FIGS. 14 and 15 and corresponding description).

Following step 404 and possibly concurrently with performance of steps 406, 408, and 410, step 412 may be performed, in which one or more mechanical and electronic components are transitioned in preparation for launch mode. Step 412 may include some or all of the following actions:
Lowering the suspensions 120 (e.g., to a lowest ride height).
Heating or cooling the battery 110 to within a predefined range of temperatures suitable for generating the large amount of current developed during a launch.
Heating or cooling one or more motors 302 to within a predefined range of temperatures suitable for generating the large amount of torque developed during a launch.
Raising limitations on some or all of current generation by the battery 110, torque generation by the one or more motors 302, temperature of the battery 110, temperature of the one or more motors 302, temperature of the power module 114, or other limitations that are imposed to promote longevity of one or more components of the vehicle 100.
Adjusting behavior of one or more electronic components to one or both of (a) promote increased torque output and (b) suspend limitations imposed during normal driving. For example, any of the attributes of the VDM ECU 210 described above may be adjusted to promote high acceleration and suspend limitations that would otherwise limit acceleration in normal operation.
Reducing the steering response 234 such that, for a given angular displacement of a steering wheel or yoke, the corresponding angular displacement of the steered road wheels 105 of the vehicle 100 is reduced compared to steering response before the reduction.

When the verifications of steps 406, 408, and 410 are complete, the method 400 may include evaluating, at step 414, whether the transition of step 412 is complete. If not, a hold message may be displayed at step 416. For example, the hold message may indicate that launch control is not yet available. In some embodiments, if the transition of step 408 is not completed, then launch control is not enabled, and output may be displayed on a front display 104 to indicate this fact. For example, if the condition (e.g., temperature) of the battery 110, motors 302, or other components of the vehicle 100 are not within a range suitable for performing a launch, then the launch control drive mode is not enabled. In other embodiments, if the condition (e.g., temperature) of the battery 110, motors 302, or other components of the vehicle are not within a range suitable for performing a launch, launch control may still be enabled but with limitations (e.g., on current generation) imposed based on the condition of the battery 110, motors 302, or other components. Step 416 may continue until step 408 is completed.

Once the verifications of steps 406, 408, and 410 are completed and the transition of step 412 is completed, launch control may be enabled. Releasing the brake pedal 318 may be detected at step 418, which invokes launching of the vehicle at step 420. Launching of the vehicle 100 may include supplying current to the one or more motors 302 at a rate that is above that permissible for sustained (e.g., longer than one minute) operation but below that which will cause failure of the motors 302 during a brief period (e.g., one minute or less). Launching of the vehicle 100 may include supplying current from the battery 110 at a rate that is above that permissible for sustained (e.g., longer than one minute) operation but below that which will cause failure of the battery 110 for a brief period (e.g., one minute or less). Launching the vehicle may include developing torque on the road wheels 105 of the vehicle 100 that is slightly (e.g., within 50, 20, 10, or 5 Newton-meters) less than a torque that will cause the road wheels 105 to slip. In some embodiments, torque is generated such that some wheel slip is achieved, e.g., between 1 and 30 degrees on launch.

In some embodiments, the method 400 may include additional steps prior to step 418 either by default or as configured by a user. For example, following step 416, recording by one or more of the exterior cameras 102 may start at step 422. The recording may be to a rolling buffer such that the last X minutes of video are retained, where X is the length of a typical run (e.g., quarter mile run) plus some additional time. For example, the retained video may have a duration of from 45 seconds to 1.5 minutes or some other duration.

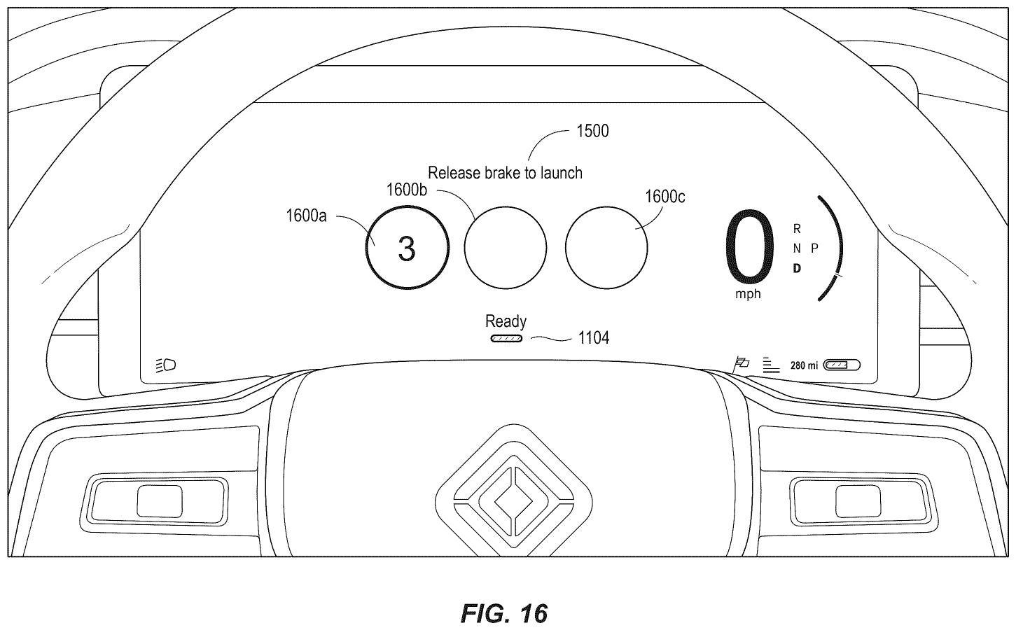

In some embodiments, the method 400 may include providing, at step 424, a countdown to a start time. An elapsed time between the start time and detecting lifting of the brake pedal 318 at step 418 may be recorded as the reaction time of the driver. An example interface for displaying a countdown is described below with respect to FIGS. 16-19.

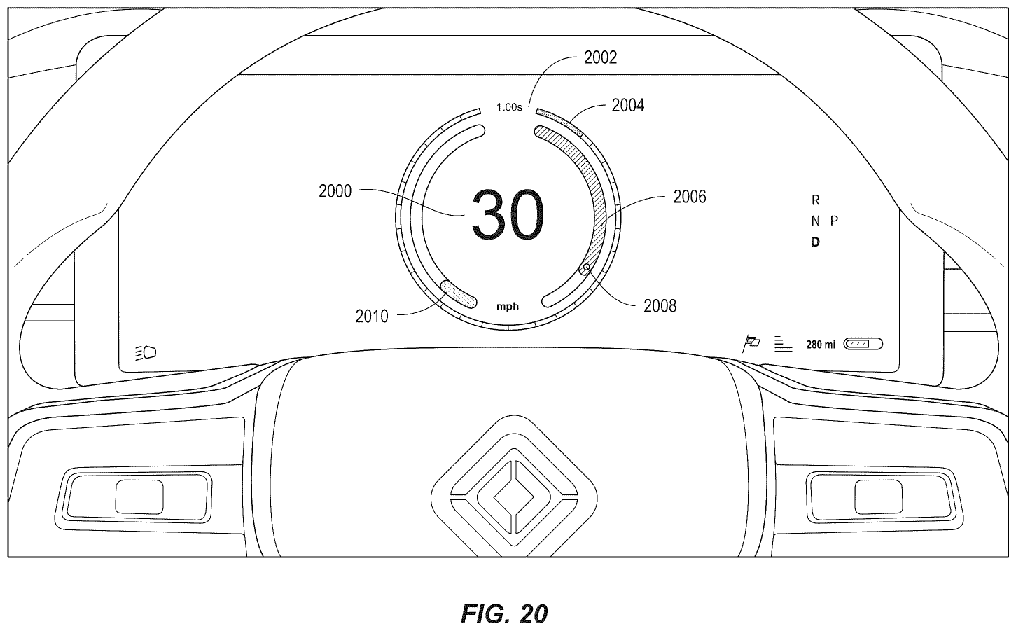

Following launching of the vehicle at step 420, the method 400 may include collecting and presenting data at step 426 for a run following the launch. The data may be collected following launch and may include pre-launch data as well, such as video captured at step 422 prior to the launch. Examples of data that may be collected and interfaces for displaying such data are described below with respect to FIGS. 20-41. Examples of data that may be collected include a 0 to 60 miles per hour time, 0 to 100 miles per hour time, eighth of a mile time, quarter mile time, time to top speed, top speed, steering angle throughout a run, tire slip during a run. A run may be defined as a span of time beginning at step 418 and ending when at least one of (a) the driver presses the brake pedal 318 or (b) a pre-defined milestone is achieved (e.g., a quarter mile traveled following launch).

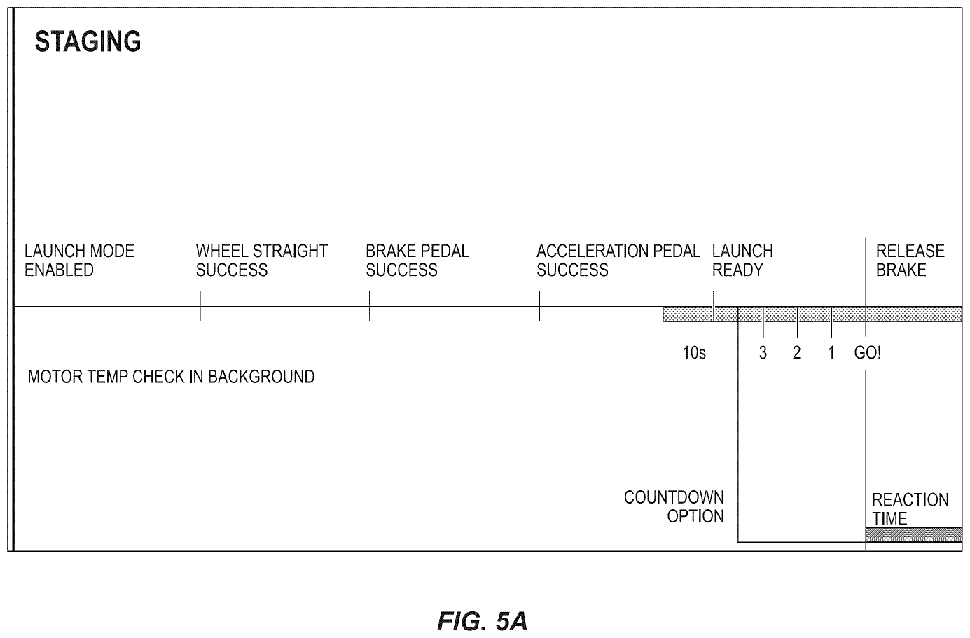

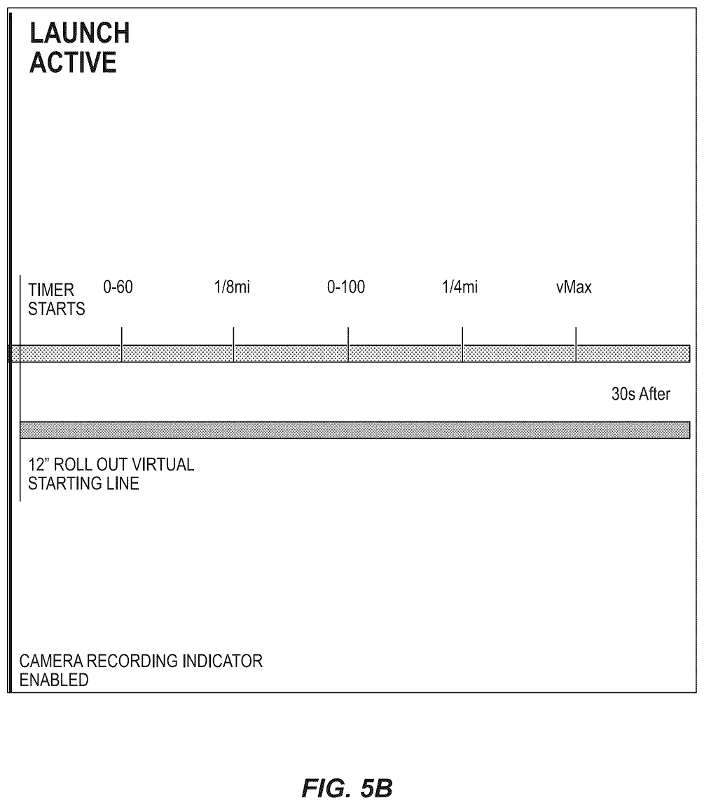

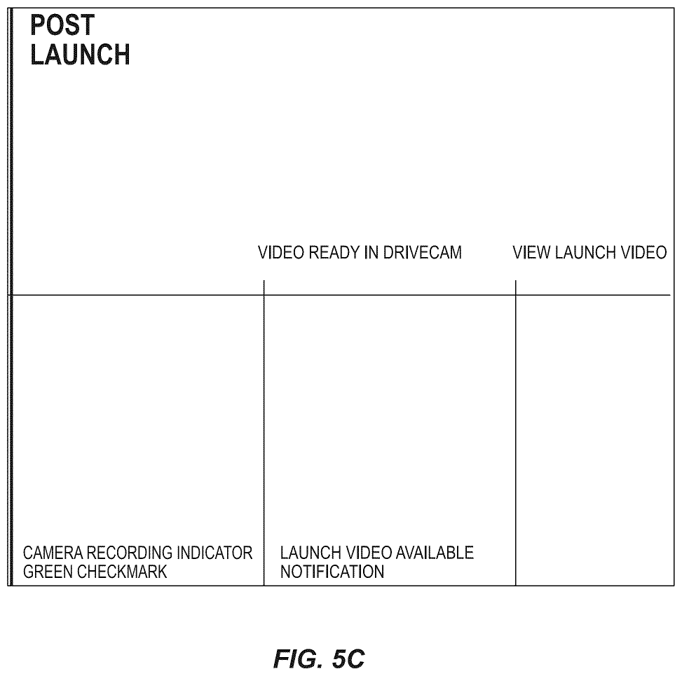

FIGS. 5A to 5C are timing diagrams illustrating the relative time of occurrence of various steps of the method 400. For example, FIGS. 5A illustrates that launch mode is enabled (steps 402 and 404), the wheels 105 are then verified to be straightened (step 406), the brake pedal 318 is verified to be depressed (step 408), and the accelerator pedal is verified to be depressed (step 410). Meanwhile, checks are performed in the background as part of step 412 (“motor temp check in background”). At some point following steps 410 and 412 being complete, the vehicle is ready to launch (“Launch Ready”) and a countdown may be started. Video recorded using the exterior cameras 102 may be retained starting from a time period prior to the start time specified by the countdown, e.g., 10 seconds. (“10 s Before” in FIG. 5A). A time between the end of the countdown (“Go!”) and releasing of the brake by the driver, is recorded as the reaction time.

Referring to FIG. 5B, in some embodiments, a timer for the run starts after a delay, such as a delay corresponding to 12 inches of rollout, as would be typical for a run timed at a drag strip. The time records the time required to reach one or more milestones, such as 60 miles per hour, 100 miles per hour, a quarter mile, and maximum velocity (“vMax”). Video recording may continue to be retained until some period after the last milestone is reached, such as 30 seconds longer or less. While the camera recording is being retained, a camera recording indicator may be enabled.

FIG. 5C illustrates the timing of actions that may be performed following a run. For example, video recorded during the run may be made available for viewing (“video ready in drivecam”) and then viewed upon receiving an input requesting display of the video (“view launch video”). Following a run, successful recording of video may be indicated (“camera recording indicator green checkmark”) and availability of the video may be indicated (“launch video available notification”).

FIGS. 6 to 41 illustrate example interfaces that may be used to invoke actions performed during the method 400, provide instructions to the driver, and display results. In the following description, interfaces are described as being presented on either a driver display or center display of the front displays 104. These placements are exemplary only and other configurations, including a single front display, are also possible. The driver display may be located in front of a steering wheel and at least partially overlap a lateral position of the steering wheel. The center display may be located laterally between driver and passenger seating positions. For example, the center display may be intersected by the center line of the vehicle 100.

FIG. 6 illustrates an interface that may be displayed on the center display to facilitate selection among multiple drive modes, including selecting the launch mode. The interface may include a menu 600 including interface elements 602 that, when selected, invoke selection of a drive mode of a plurality of drive modes (“all-purpose,” “sport,” “all-terrain,” “snow,” “soft sand”). The menu 600 may further include interface elements 604 that display attributes of the vehicle as configured according to a selected drive mode and receive inputs invoking adjustment of the attributes. The attributes may include any of the attributes 222-240 of FIG. 2B, such as ride height 226, suspension stiffness 222, regenerative braking behavior 232, and stability control behavior 240.

In the illustrated interface, when the “sport” drive mode is selected, the interface elements 604 further include an interface element 606 that, when selected by a user, invokes launch mode (step 402). The interface may further include a representation 608 of the vehicle 100. The representation 608 may be generated using cell shading or other rendering approach and may illustrate the vehicle 100, e.g., the paint color, model, wheels 105, and possibly other externally visible attributes of the vehicle 100. The representation 608 may include a scene corresponding to the selected drive mode, e.g., the illustrated racing scene corresponding to selection of the “sport” drive mode.

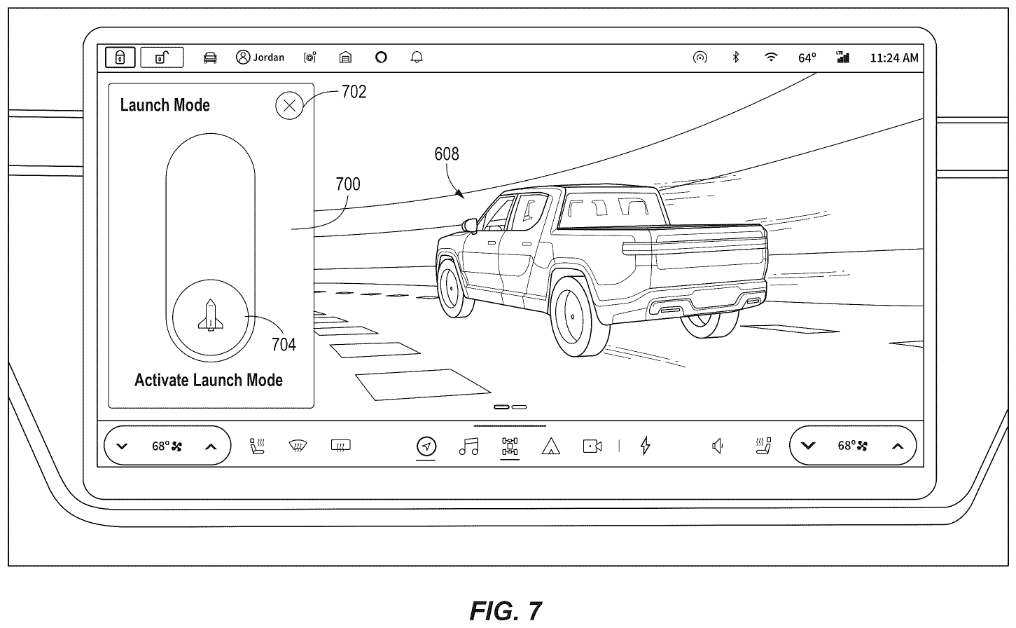

Referring to FIG. 7, the illustrated menu 700 may be displayed on the center display in response to selection of the interface element 606. The menu 700 may be used to receive confirmation of selection of launch mode at step 404. The menu 700 may include an interface element that, when selected, invokes exiting of launch mode, i.e., declining to confirm selection of launch mode. The menu 700 may include a slider 704 that the user may touch and slide upwards to confirm selection of the launch mode. The use of a slider 704 may ensure that selection is an intentional act rather than inadvertent contact with the touch screen of the center display. Sliding is one example of a gesture that may be used. Other gestures, other than tapping, may be used to confirm intentional selection of the launch mode. A user may exit launch mode by selecting interface element 702.

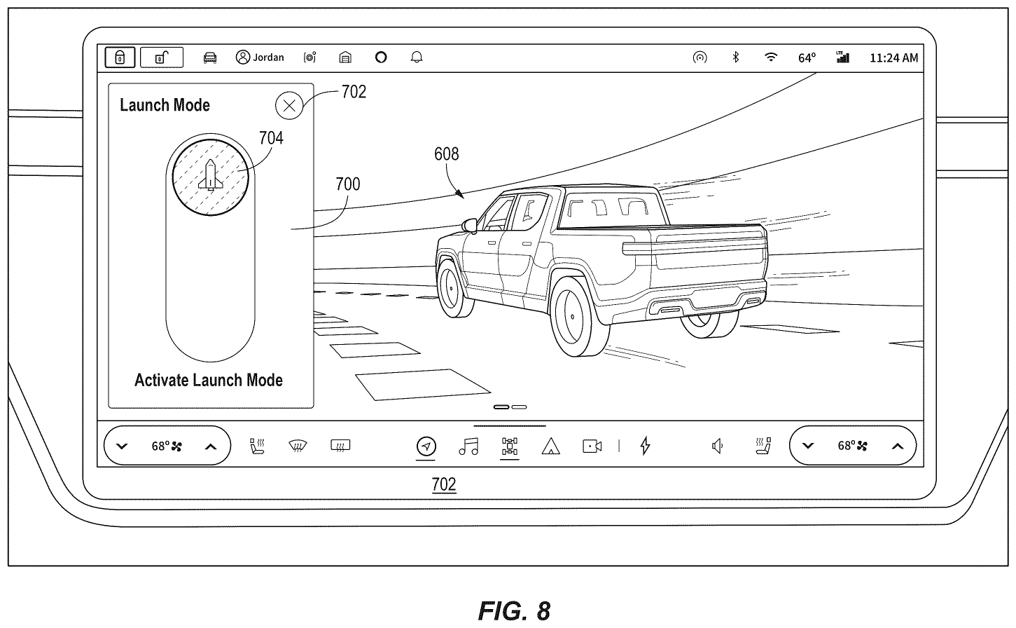

FIG. 8 illustrates the slider 704 after being slid upwards by a user to confirm selection of launch mode. The slider 704 may change in color (e.g., black to yellow) in response to being slid to the position of FIG. 8.

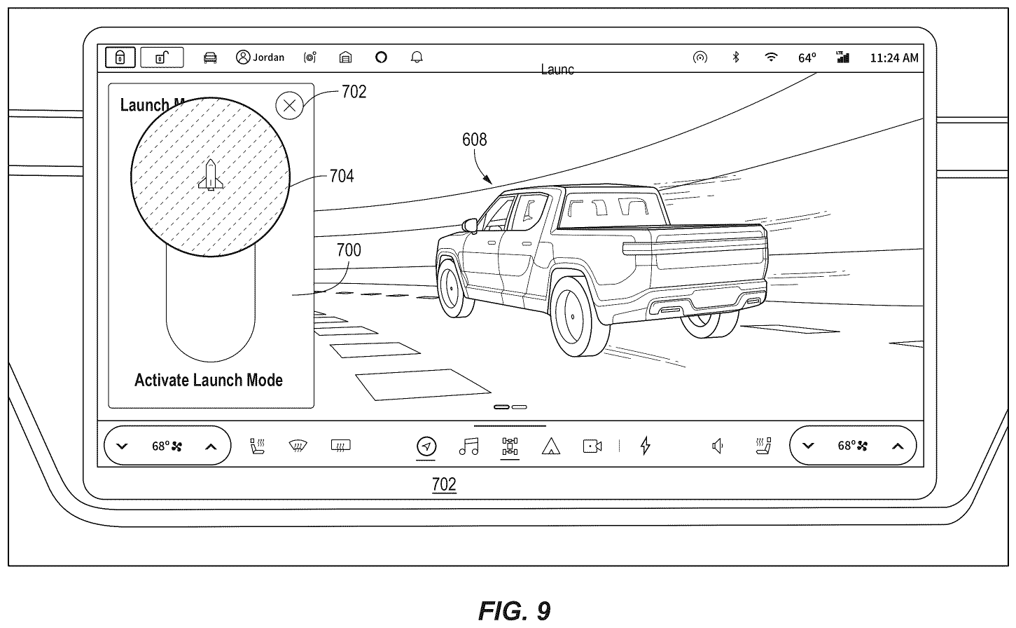

FIG. 9 illustrates an animation that may accompany confirmation of selection of launch mode. For example, the slider 704 may expand to fill the entire menu 700.

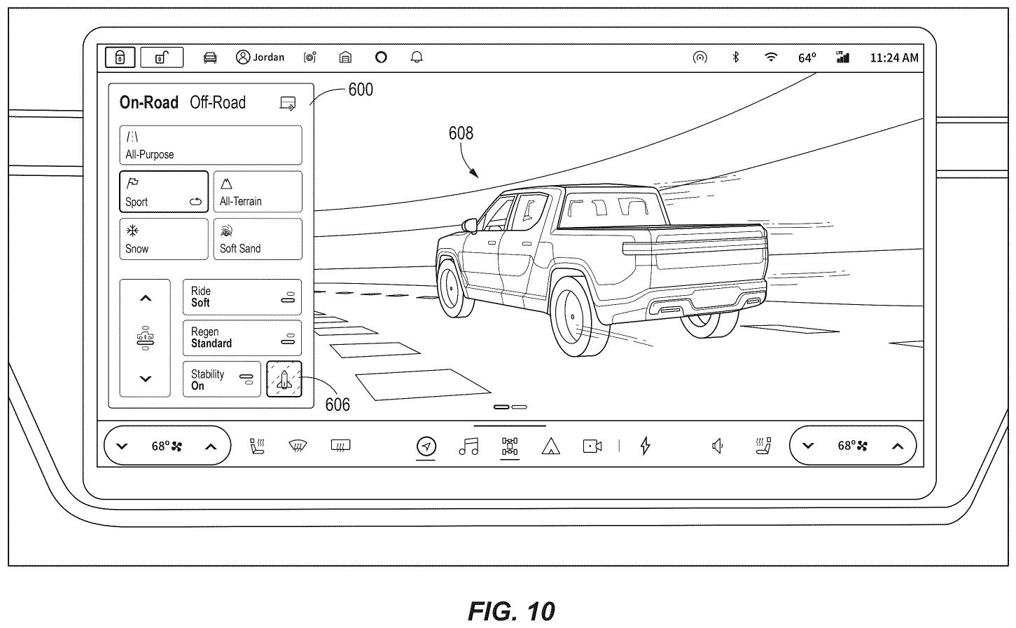

FIG. 10 illustrates the menu 600 following confirmation of the selection of launch mode, such as after completion of the animation of FIG. 9. The appearance of interface element 606 may change to indicate successful selection of launch mode. For example, the interface element 606 may change in color, shape, intensity, or any other visual attribute. Any of text, a symbol, or graphics on the interface element 606 may also change. In the illustrated embodiment, the interface element 606 changes from light gray to yellow.

FIG. 11 illustrates an interface for instructing the driver to participate in verification that the steered road wheels 105 are straight at step 406. The interface may include one or more interface elements 1100a, 1100b, 1100c that indicate whether the steered road wheels 105 are sufficiently straight. For example, interface element 1100a is a dot that may be moved around a point to indicate the current angle of the steered road wheels 105. When the dot is at its highest point, the steered road wheels 105 are straight in some embodiments. Interface element 1100b may be a graphical representation of the steering wheel and likewise move in correspondence with movement of the steering wheel. Interface element 1100c may be a circle, such as surrounding interface elements 1100a and 1100b. Interface element 1100c may be modified in various ways to visually indicate the state of the road wheels 105. The interface element 1100c may be an arc when the steered road wheels 105 are not straight with a size and position of a gap defined by the arc indicating to which side the steered road wheels 105 are turned. When the arc becomes a circle, the steered road wheels 105 are sufficiently straight. When the road wheels 105 are sufficiently straight, the interface element 1100c, and possibly the interface elements 1100a, 1100b, may change color, such as from white to green (see FIG. 12).

An interface element 1102 may also be displayed that indicates with text or other symbols whether the steered road wheels 105 are straight and possibly a direction in which the steered road wheels 105 should be turned to become straight.

An interface element 1104 may be displayed in the interface element and other interface elements used as part of steps 406, 408, and 410. The interface element 1104 may communicate a state of execution of step 412. The interface element 1104 may include text indicating whether step 412 is completed (“not ready”) and may include a status bar providing a visible representation of the fraction of step 412 is completed. When step 412 is completed, interface element 1104 may indicate this fact (“ready”) or may be removed entirely.

FIGS. 12, 13, and 14 illustrate the interface element 1100a forms a circle and may change color when the steered road wheels 105 are straight, such as by a ring at the perimeter of the interface element 1100a turning brighter or a different color, e.g., from light gray to green. In the illustrated embodiment, interface element 1100a is removed when the steered road wheels 105 are straight. Once step 406 is completed, the interface may be updated. For example, one or more interface elements 1200a, 1200b may become active and represented as such, e.g., changed to a different color (e.g., white). Interface elements 1200a, 1200b may be present in the interface of FIG. 11 but represented as inactive (e.g., grayed out) until step 406 is completed.

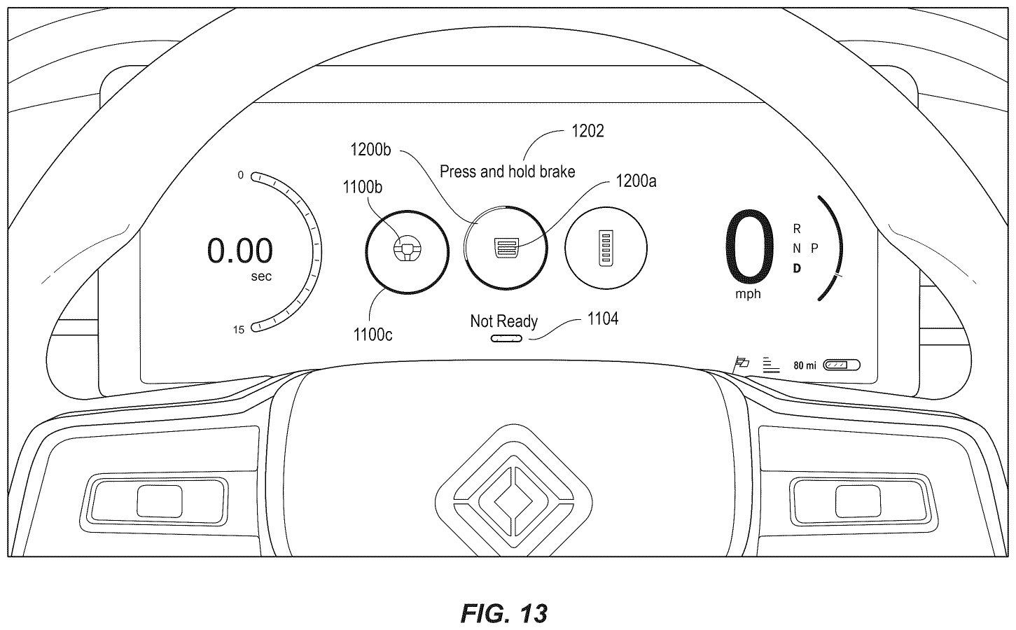

Interface element 1200a may be graphical representation of the brake pedal 318 and may change color (e.g., to green) when the brake pedal 318 is depressed to at least a predetermined brake pedal position. Interface element 1200b may be an arc that grows as the brake pedal 318 is depressed (see FIG. 13) such that the size of a gap defined by the arc indicates a difference between the position of the brake pedal and the predetermined brake pedal position. The arc becomes a circle when the brake pedal 318 is depressed to at least the predetermined brake pedal position (see FIG. 14).

Interface element 1202 may likewise be displayed following completion of step 406 and instruct the driver to depress the brake pedal 318 (“press and hold brake”).

FIG. 14 further illustrates an interface that may be displayed as part of implementing step 410. For example, following completion of step 408, interface elements 1400a, 1400b may become active and represented as such, e.g., changed to a different color (e.g., white). Interface elements 1400a, 1400b may be present in the interface of FIGS. 11, 12, and 13 but represented as inactive (e.g., grayed out) until step 408 is completed.

Interface element 1400a may be graphical representation of the accelerator pedal 316 and may change color (e.g., to green) when the accelerator pedal 316 is depressed to at least a predetermined accelerator pedal position. Interface element 1400b may be an arc that grows as the accelerator pedal 316 is depressed and becomes a circle when the accelerator pedal 316 is depressed to at least the predetermined accelerator pedal position (see FIG. 15). A size of a gap defined by the arc may correspond to a difference between the position of the accelerator pedal and the predetermined accelerator pedal position.

Interface element 1402 may likewise be displayed following completion of step 408 and instruct the driver to depress the accelerator pedal 316 (“press and hold accelerator”).

FIG. 15 further illustrates an interface that may be displayed following completion of step 410. Interface element 1104 may continue to indicate that step 412 is not completed following completion of step 410. When step 412 is completed, interface element 1104 may be updated to indicate this fact (“ready”). Interface element 1200b may be updated. For example, the circle may be filled, such as with a green color indicating that action should be performed with respect to the brake pedal 318. An interface element 1500 may be displayed and indicate that launch may be invoked by releasing the brake pedal 318.

Following completion of step 410, at possibly at some other point prior to step 420, a driver may invoke a countdown as described above with respect to step 424. For example, a user may invoke display of a countdown by pressing a button 1502 on the steering wheel or interacting with other physical button or interface element on the driver display or center display. A countdown may also be invoked by changing a setting of the vehicle 100 prior to or during implementation of the method 400.

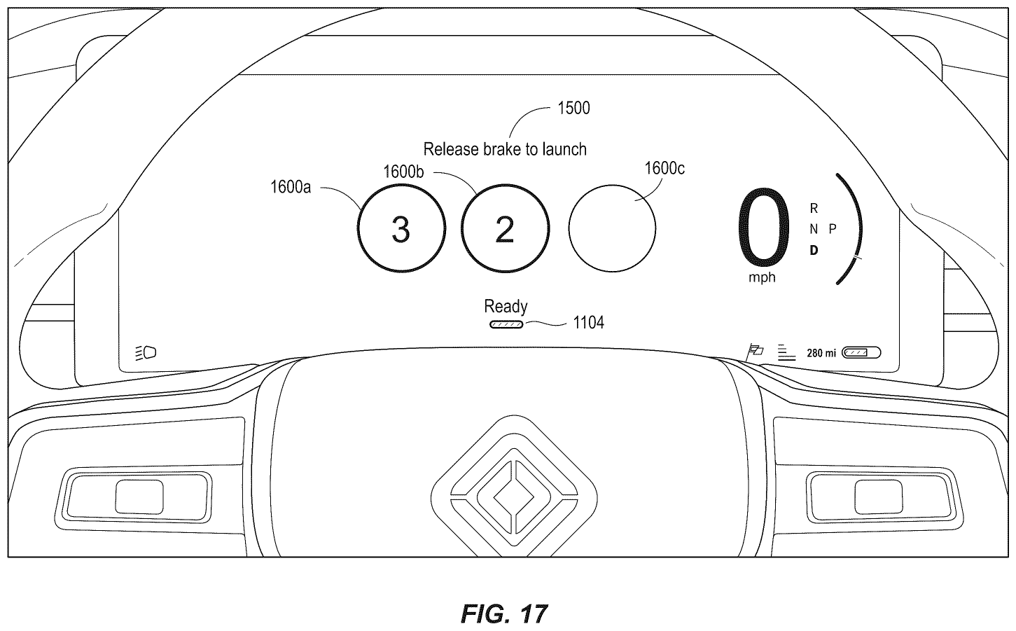

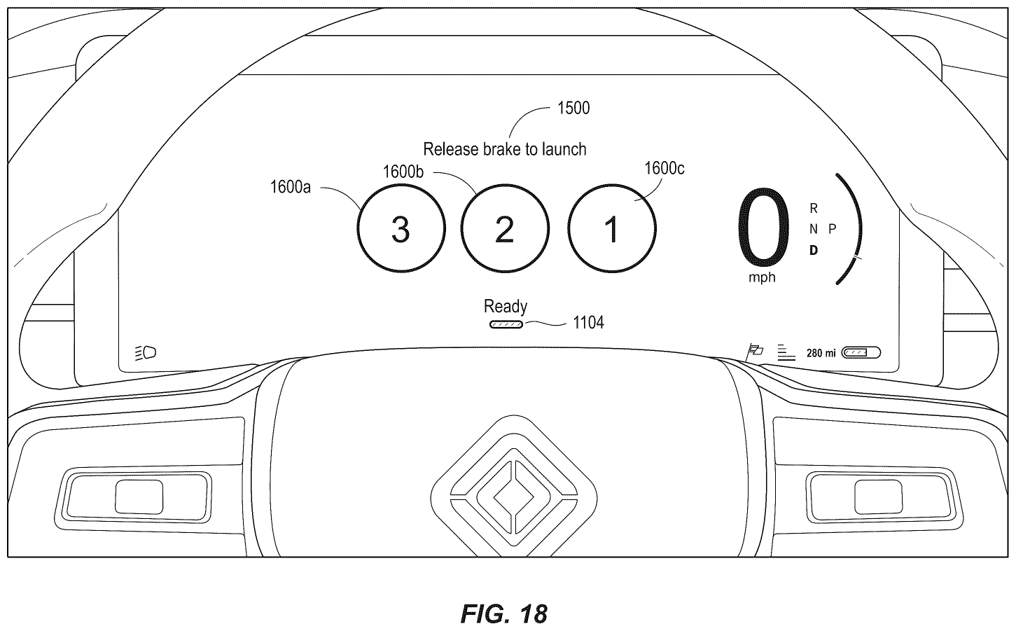

FIGS. 16, 17, and 18, and 19 illustrate the progression of interface element 1600a, 1600b, and 1600c to implement a countdown. In FIG. 16, interface element 1600a is highlighted (e.g., changed from light gray to another color, such as yellow). A number (“3”) may also be shown in interface element 1600a. In FIG. 17, one second after interface element 1600a is highlighted, interface element 1600b is highlighted in the same manner and a number (“2”) may be displayed therein. In FIG. 18, one second after interface element 1600b is highlighted, interface element 1600c is highlighted in the same manner and a number (“1”) may be displayed therein. In FIG. 18, one second after interface element 1600c is highlighted, all of the interface elements 1600a, 1600b, 1600c are visually modified, such as by changing color (e.g., from yellow to green) and/or being filled with a different color. User interface element 1500 may remain displayed throughout the countdown.

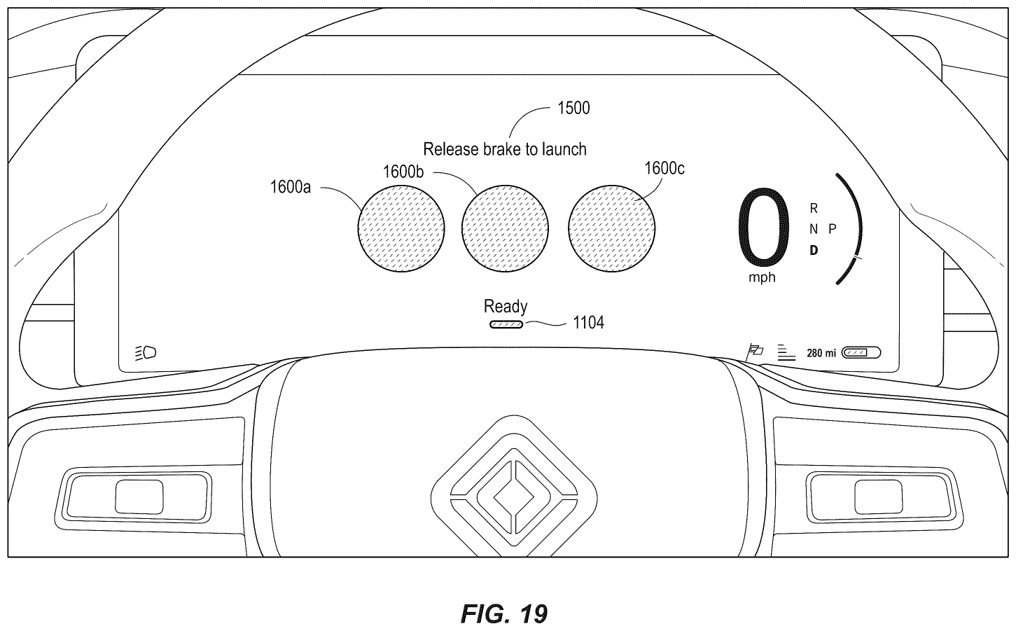

FIG. 20 illustrates an interface that may be displayed on the driver display during a run. The interface of FIG. 20 may be displayed following display of the interface of FIG. 19. For example, the interface of FIG. 19 may be displayed for 0.2 to 1 seconds, followed by display of the interface of FIG. 20. The interface may be used to display data collected during a run as part of step 426.

The interface of FIG. 20 may include an interface element 2000 displaying the current speed of the vehicle 100 with decimal digits. Interface element 2002 may display the current time of the run (e.g., following the end of the countdown, following release of the brake where no countdown is used, or other reference point) in decimal digits. Reference element 2004 may be an arcuate element with a highlighted portion (e.g., having a different color or brightness) of the arcuate element representing distance traversed in the run. Tic marks on the arcuate element may represent units of distance, such as every 20 feet, 100 feet, 1/32^{nd} of a mile, or some other distance.

Interface element 2006 may be an arcuate element with a highlighted portion representing power output of the battery 110 or of the one or more motors 302. The interface element 2006 may include a marker 2008 indicating zero power consumption such that highlighting a portion of the arcuate element to one side of the marker 2008 indicates power consumption and highlighting a portion of the arcuate element on the other side of the marker 2008 indicates power generation. The highlighted portion of the interface element 2006 may therefore grow from the marker 2008. The color of the highlighted portion of interface element 2006 may indicate information, e.g., blue for consumption, green for regeneration.

Interface element 2010 may include an arcuate element with a highlighted portion of the interface element 2010 indicating speed. The total length of the arcuate element may correspond to a top speed of the vehicle 100.

The arcuate elements 2004, 2006, 2010 may conform to circles centered on a center of interface element 2000. The interface elements 2002-2010 may be updated in real time during a run (e.g., less than a 10-millisecond delay).

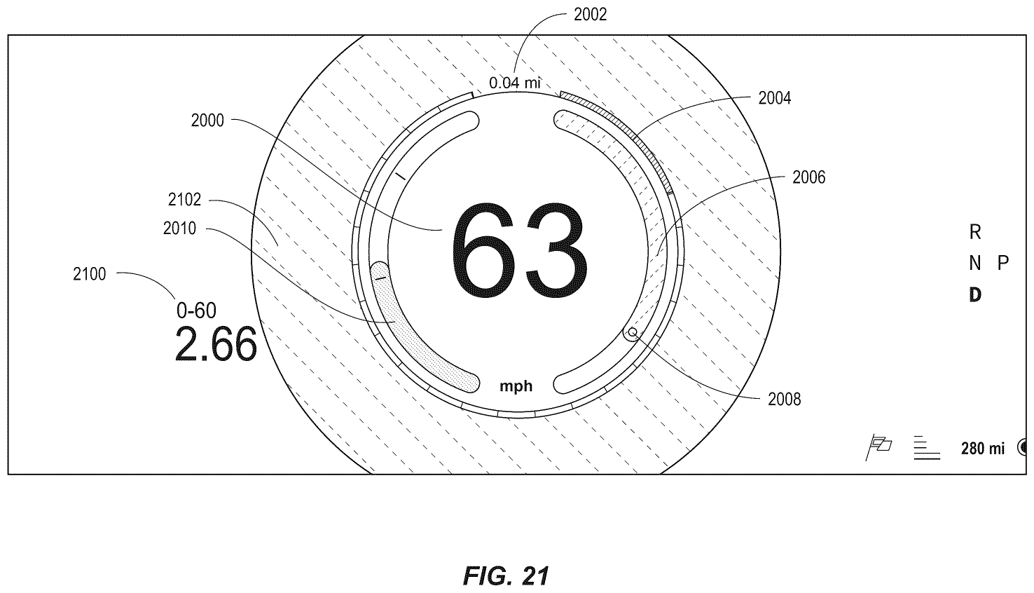

Referring to FIG. 21, in some embodiments, the interface of FIG. 20 may be augmented with additional information when a milestone is reached, such as 60 miles per hour, 100 miles per hour, an eighth of a mile, a quarter mile, or reaching the top speed of the vehicle 100. The additional information may include a representation 2100 of data describing the milestone, such as interface element 1500 including a time (“2.66”) and the significance of the time (“0-60”). The additional information may include a celebratory display, such as the illustrated interface element 2102 including a region of a highlighting color expanding outwardly from the interface elements 2002-2010, such as until the outer edge of the driver display is reached.

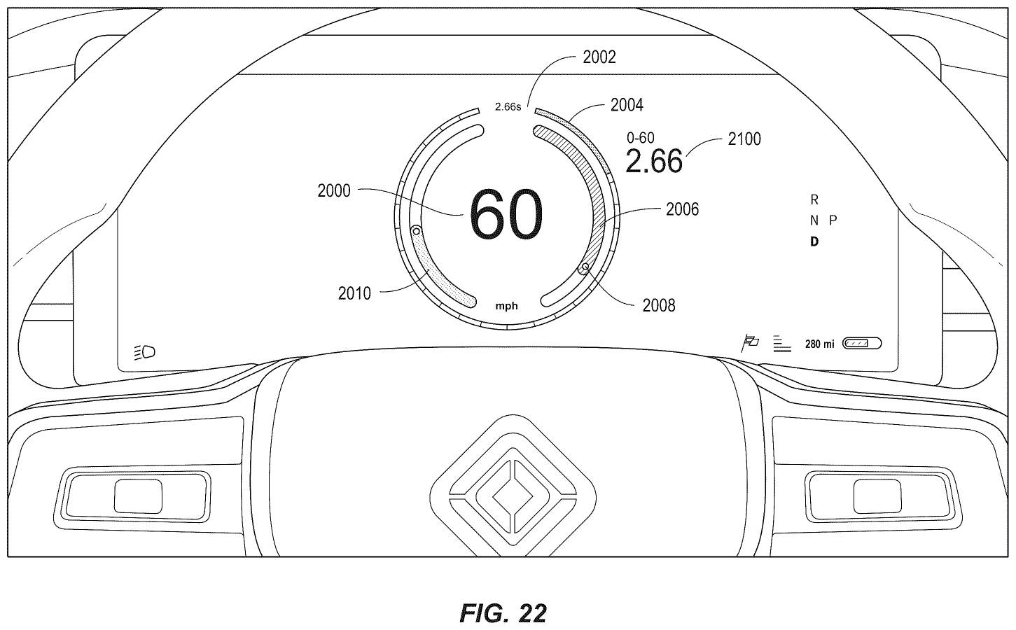

Referring to FIG. 22, following the celebratory display, the representation 2100 including the data describing the milestone may continue to be displayed along with the interface elements 2002-2010.

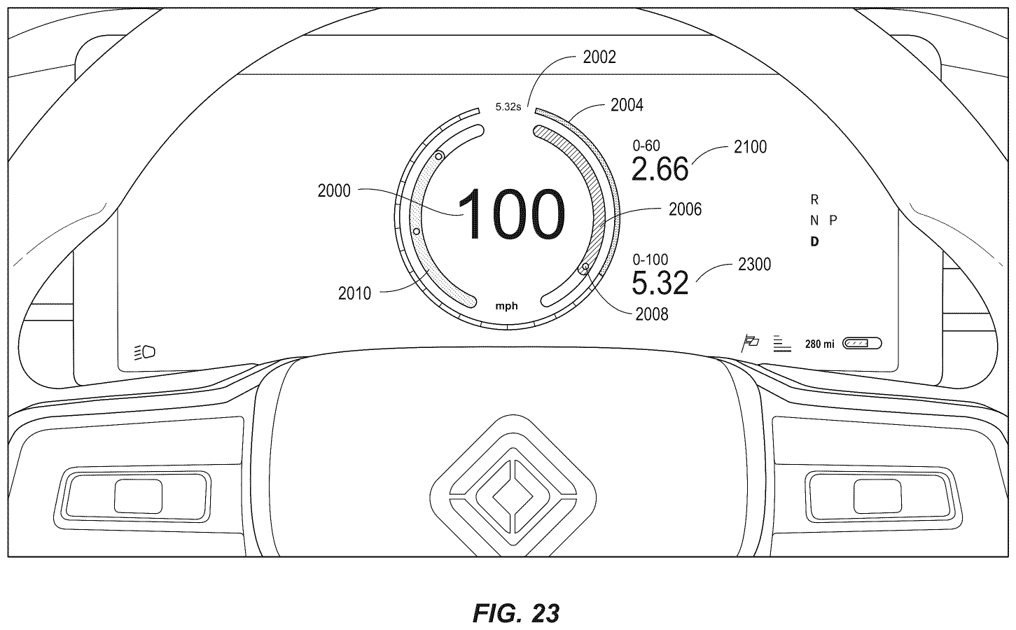

Referring to FIG. 23, as additional milestones are reached, additional interface elements 2300 may be added to reflect this fact. For example, element 2300 includes a time (“5.32”) and a significance of the time (“0-100”). Display of the element 2300 may be accompanied by a celebratory display as shown in FIG. 21.

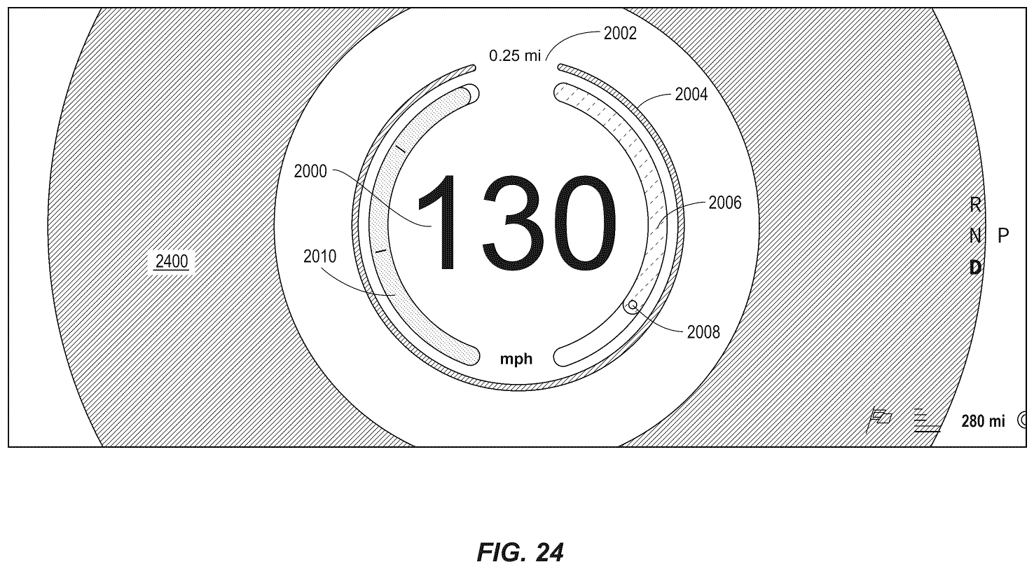

Referring to FIG. 24, illustrates a celebratory display 2400 that may be displayed along with interface elements 2002-2010 upon reaching a milestone, such as ¼ mile. The celebratory display 2400 may be an expanding ring of a highlighting color (e.g., blue) expending outward from the interface elements 2002-2010. The display of FIG. 24 may be accompanied by outputting an audible signal, such a chime, tune, recorded verbal message, or other audible signal

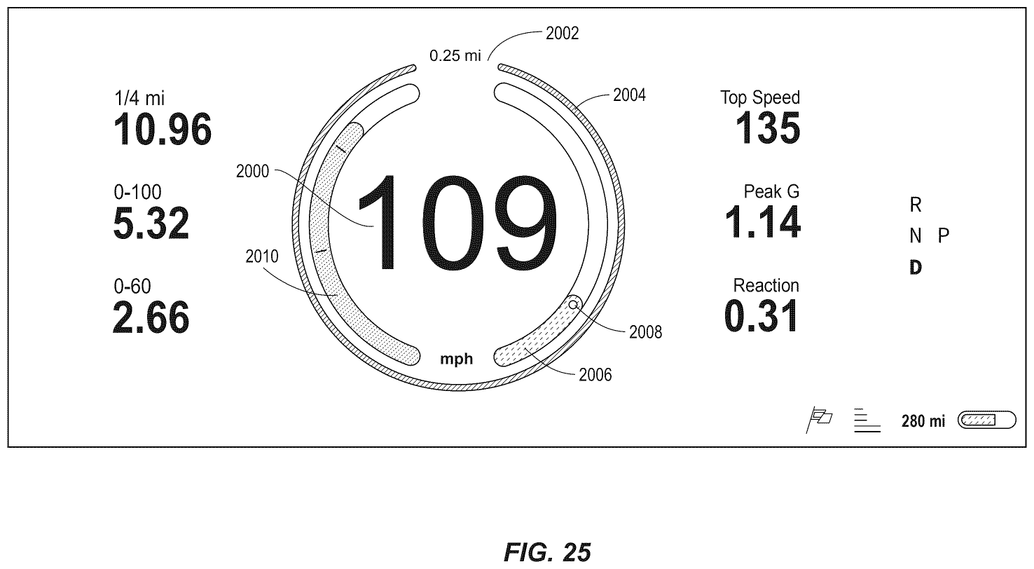

Referring to FIG. 25, once a run is completed (e.g., a final milestone, such as the ¼ mile, is reached), data collected during the run may be displayed either alone or along with the interface elements 2002-2010. As shown, this data may include a quarter mile time, 0-100 time, 0-60 time, top speed, peak acceleration (“peak G”), and reaction time. FIG. 25 further illustrates interface element 2006 indicating regenerative current in terms of position relative to the interface element 2006 and the color thereof (green).

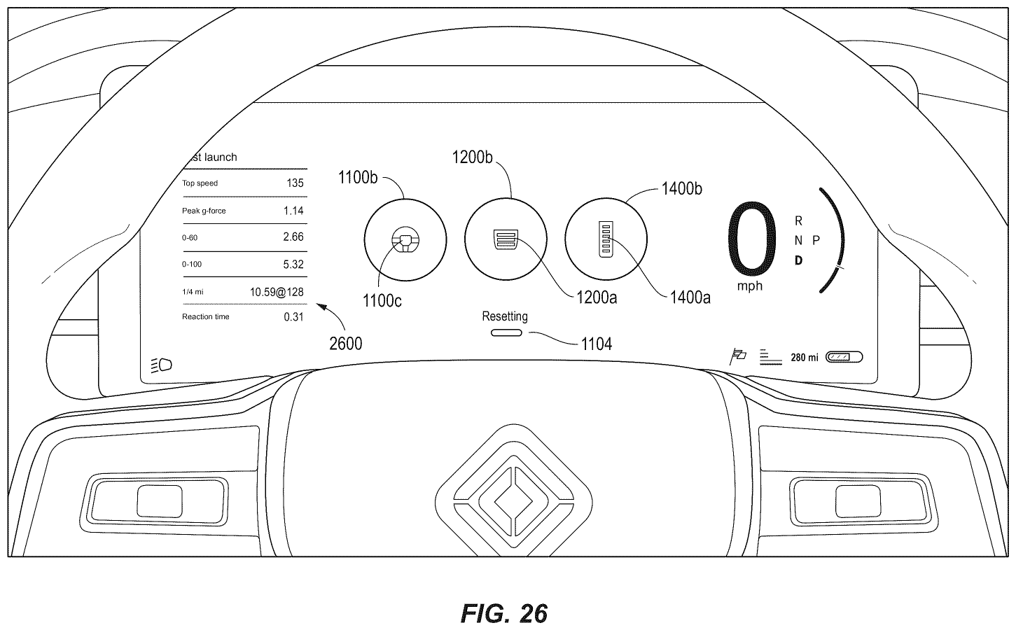

Referring to FIG. 26, following a run, and following display of the interface of FIG. 25 for a period, e.g., from 1 to 3 seconds, the driver display may reset to displaying interface elements 1100b, 1100c (and possibly 1100a), interface elements 1200a, 1200b, and interface elements 1400a, 1400b. Interface element 1104 may display the current state of the transition of step 412. In particular, for subsequent launches, step 412 may include a resetting process in which the vehicle 100 is again transitioned to launch mode. The resetting process may include cooling components in preparation for another launch. Following a run, a table 2600 listing the results of the run may also be displayed.

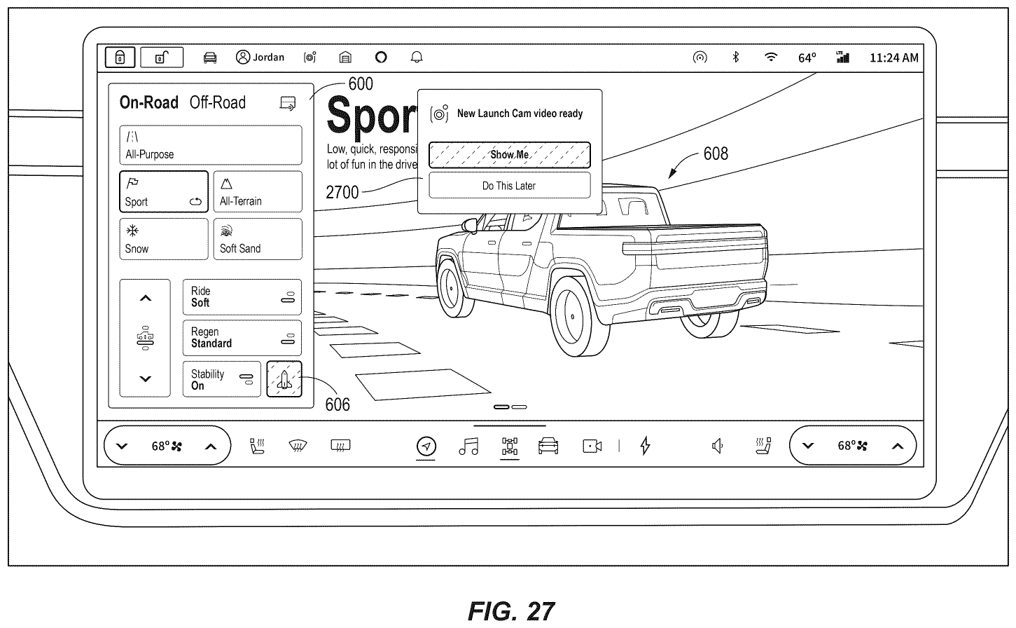

FIG. 27 illustrates an interface that may be displayed on the center display following a run. The interface may include the menu 600. Element 606 may continue to indicate that launch mode is enabled until a user disables launch mode, such as by selecting a different drive mode or selecting interface element 606. The interface may further include a menu 2700 providing interface elements enabling a user to invoke viewing of video captured during the run (“New Launch Cam video ready” and “Show Me”). The menu 2700 further enables the user to invoke skipping display of the video (“Do This Later”). The interface may include a rendering of a model of the vehicle 100, such as on a race track or other race-inspired background. The rendering may be arrived at with an animated change of viewing angle, such as to a viewpoint rearward of the vehicle 100. The rendering may be performed using a rendering engine, such as UNREAL ENGINE.

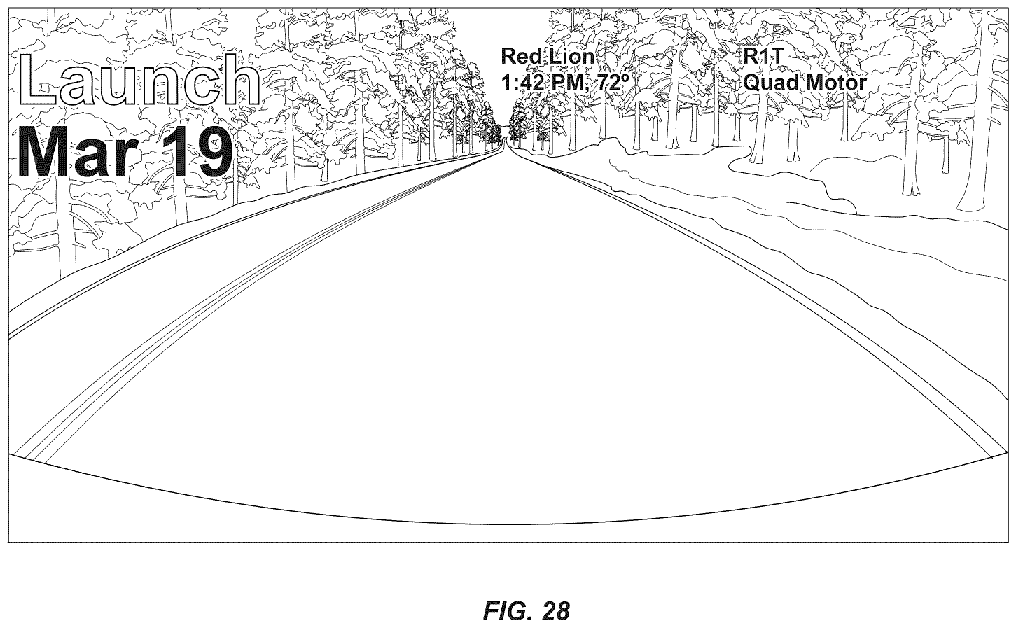

FIGS. 28 through 32 illustrate frames of a video that may be displayed for a run. The video may include images captured using the exterior cameras 102 prior to and during a run as well as superimposed information.

Referring to FIG. 28, information superimposed over first frames of the video may include a date, a location, and an indication of the model of the vehicle 100. The first frames may correspond to images captured prior to launch and possibly prior to a countdown.

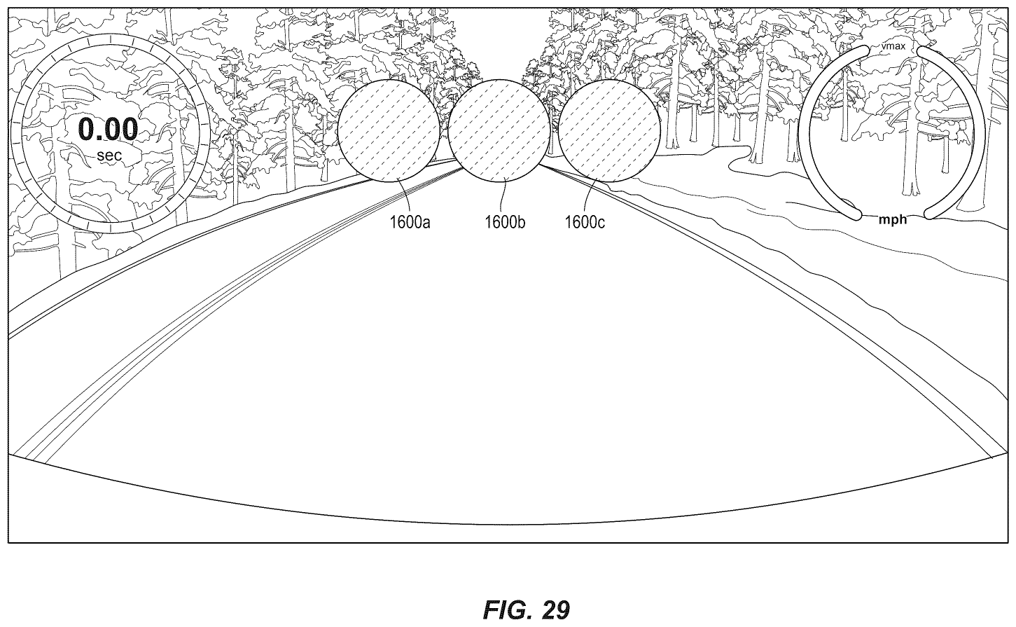

FIG. 29 illustrates information that may be superimposed over second frames of the video captured after the first frames. The information may include interface elements 1600a-1600c used to present the countdown synchronized with the second frames of video that were captured during the countdown. The information may include gauges displaying time, speed, and/or distance.

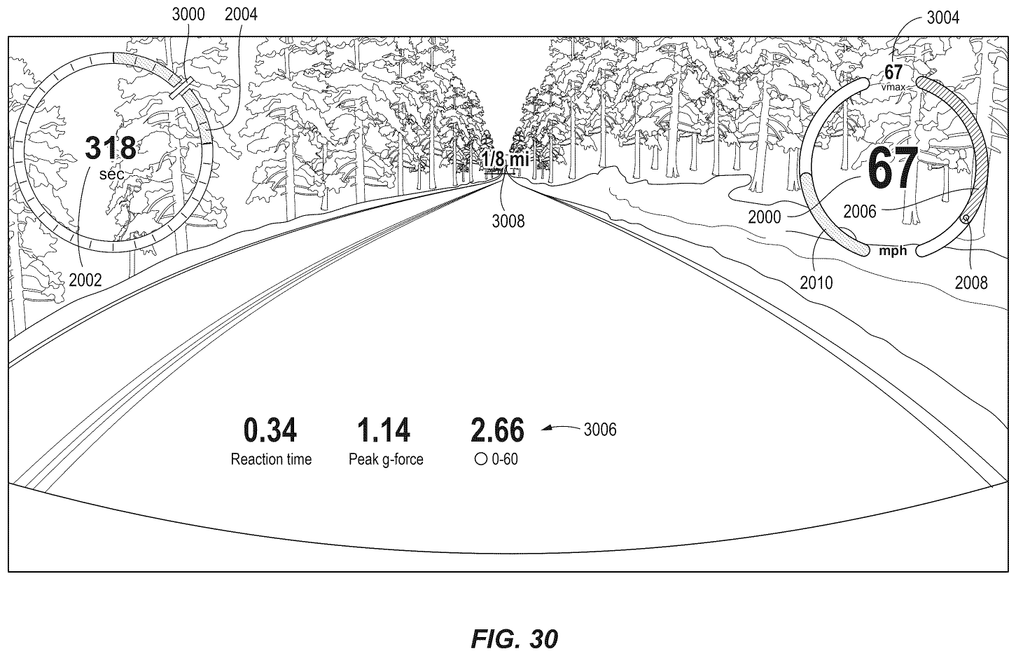

FIG. 30 illustrates information that may be superimposed over third frames of the video captured after the second frames. The illustrated information may include interface elements 2000-2010 as described above, though possibly with a different arrangement. For example, interface elements 2004 may be displayed to one side of interface elements 2000, 2006 and 2010, rather than the concentric arrangement of FIG. 20. In the illustrated embodiment, the arcuate shapes of interface elements 2006 and 2010 are concentric and interface element may be placed at a center of circles defined by the interface elements 2006 and 2010. In the illustrated embodiment, interface element 2002 (time) is enlarged and placed at a center of the circle defining the arcuate element of interface element 2004.

In some embodiments, markers 3000 corresponding to milestones that have been reached may be superimposed on interface element 2004, such as the illustrated marker 3000 corresponding to a distance at which 60 miles per hour was achieved. Interface element 3004 indicating top speed may be added to a cluster of interface elements including interface elements 2000, 2008, 2006, and 2010.

Additional information superimposed on the third frames may include a listing 3006 a reaction time, peak G force, and data for milestones passed, such as the illustrated 0 to 60 time.

In some embodiments, augmented reality elements 3008 may be added. For example, augmented reality element 3008 may mark a point in a video frame representing a milestone along a route traversed during a run. For example, the illustrated augmented reality element 3008 indicates a point along a road corresponding to ⅛^{th} of a mile from a launch location.

The augmented reality element 3008 may be placed using a location of the vehicle 100 when a frame of video was captured (such as as recorded during a run by a global positioning system (GPS) receiver) to determine a current distance from the launch location, generating a three-dimensional model of a scene captured in the video, estimating additional distance to a milestone along a road represented in the three-dimensional model. The augmented reality element 3008 may then be superimposed on a frame of video at a location corresponding to the additional distance. The three-dimensional model may be obtained using images from multiple exterior cameras or a single exterior camera using known techniques for obtaining three-dimensional information from two-dimensional images.

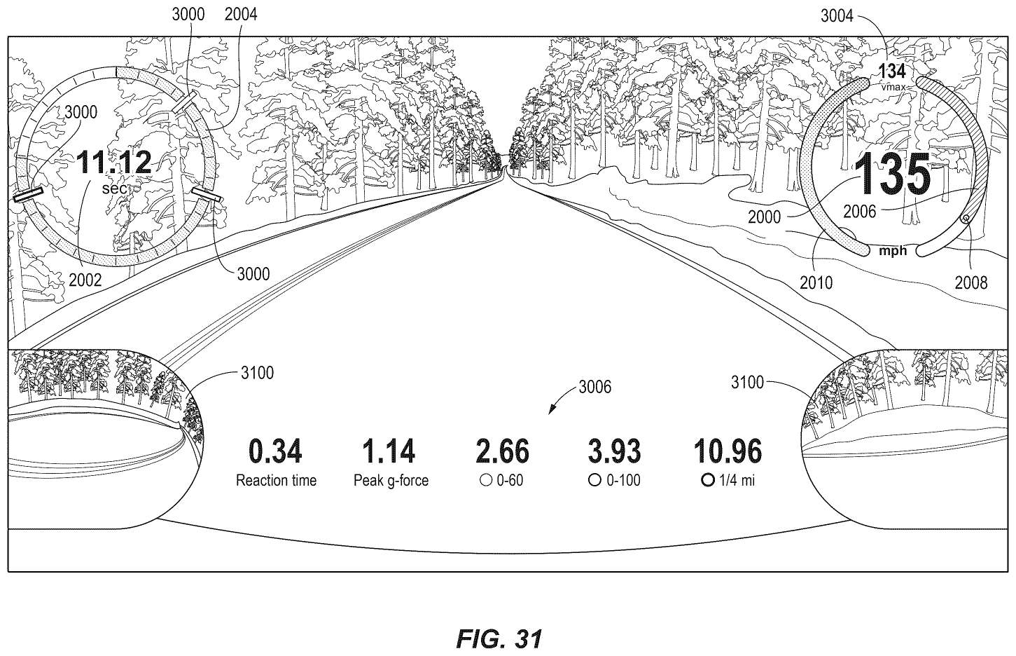

FIG. 31 illustrates third frames captured at a later point in a run than the second frames. As can be seen, the listing 3006 has been updated to include data for subsequent milestones: 0 to 100 time and ¼ mile time. Likewise, additional markers 3000 have been added to interface element 2004 indicating the locations of the subsequent milestones.

FIG. 31 further illustrates that any frames of the video may be augmented with frames of video output by one or more additional exterior cameras 102. For example, the largest image in FIG. 31 may be a frame of video captured using a forward-facing camera with smaller images 3100 superimposed thereon, the smaller images 3100 being frames of video captured using side-facing cameras, such as blind-spot monitoring cameras that may be mounted to side-view cameras or elsewhere on the vehicle 100. The frames of video from the multiple cameras may be displayed in a synchronized fashion relative to time of capture.

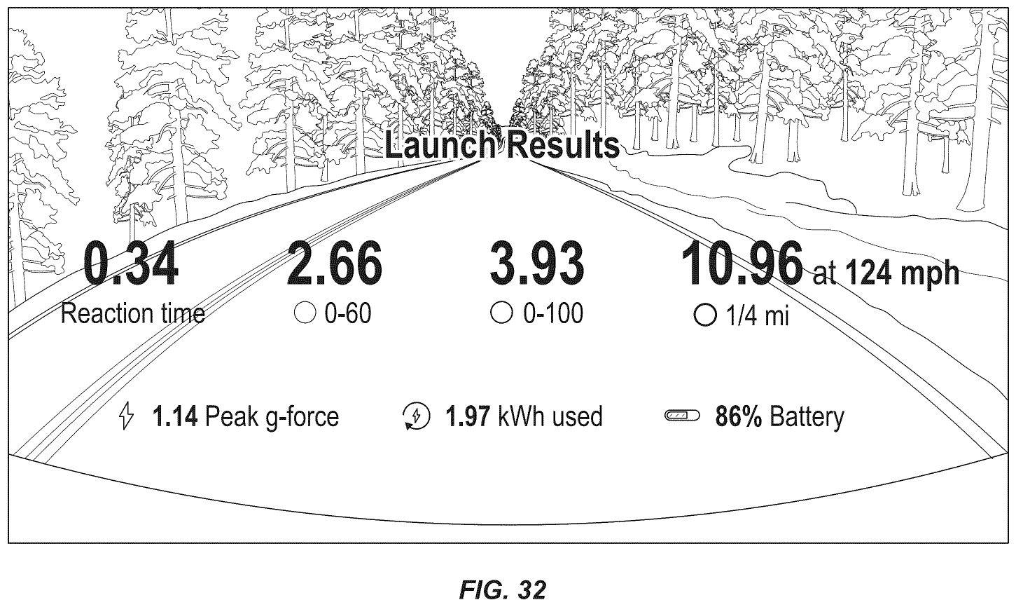

FIG. 32 illustrates information that may be superimposed over fourth frames of the video, such as those captured after a final milestone (e.g., a ¼ mile) has been reached. The fourth frames may include a summary of data collected for a run, such as reaction time, 0 to 6 0time, 0 to 100 time, ¼ mile time, speed at ¼ mile, peak G force, energy used, and a state of charge of the battery 110 prior to or following the run.

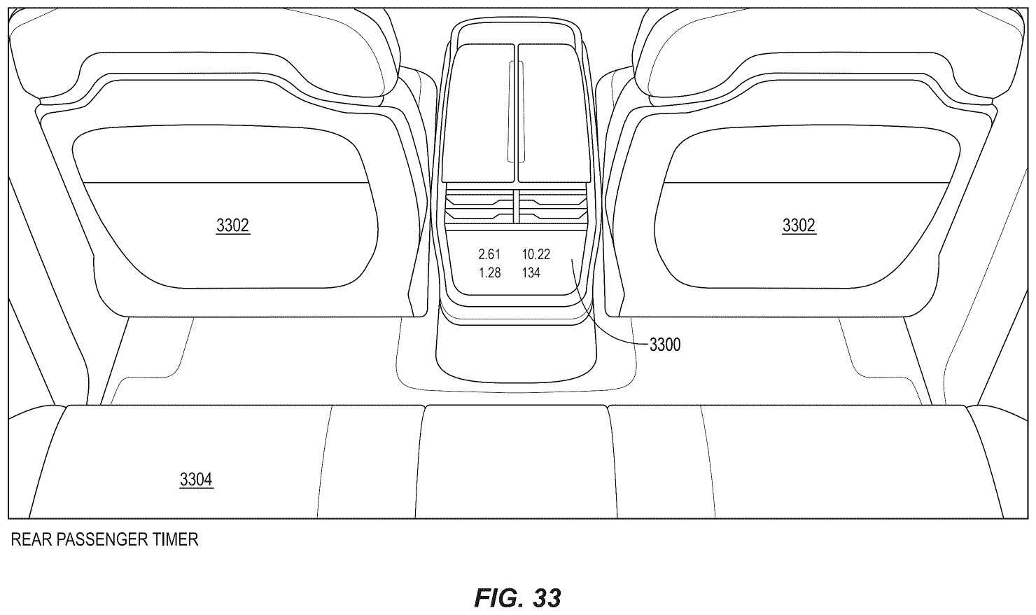

Referring to FIG. 33, the vehicle 100 may include a rear display 3300 that is located behind or overlapping with seat backs 3302 of front seats of the vehicle 100. The rear display 3300 may be viewable by passengers seated in a rear seat 3304 of the vehicle 100. The display 3300 may display video of a run as described above with respect to FIGS. 28-32. The superimposed information may be modified to accommodate a smaller size of the display 3300 and control of playback and what information may be displayed by rear passengers interacting with the display 3300, which may be a touch screen.

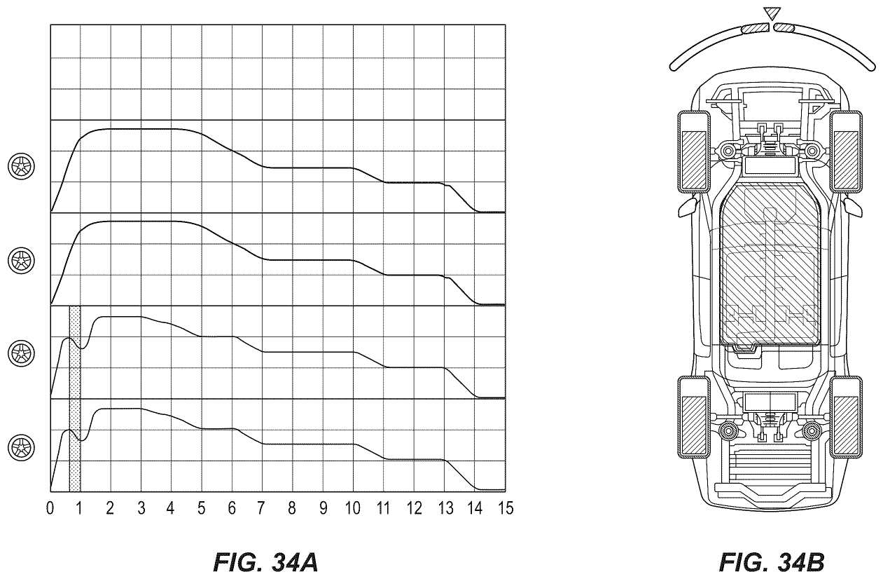

Referring to FIGS. 34A and 34B, in some embodiments, wheel slip for each road wheel of the vehicle 100 may be captured and displayed. For example, FIG. 34A includes a plot of wheel slip with respect to time or distance. Wheel slip may also be represented on a graphical representation of a chassis of the vehicle 100 as shown in FIG. 34B. A graphical representation of each wheel may be modified to indicate a degree of wheel slip, e.g., a size of a portion of the graphical representation filled with a particular color may indicate the magnitude of wheel slip.

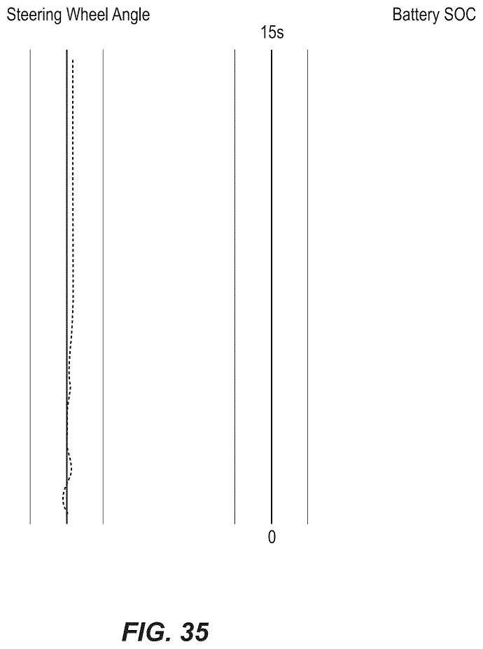

Referring to FIG. 35, the steering angle of the steered road wheels 105 may be captured and displayed during a run as shown. The vertical direction may represent time or distance and the horizontal direction may represent steering angle. Accordingly, a driver may assess how well the driver kept the vehicle 100 headed in a straight line during run in order to improve future runs.

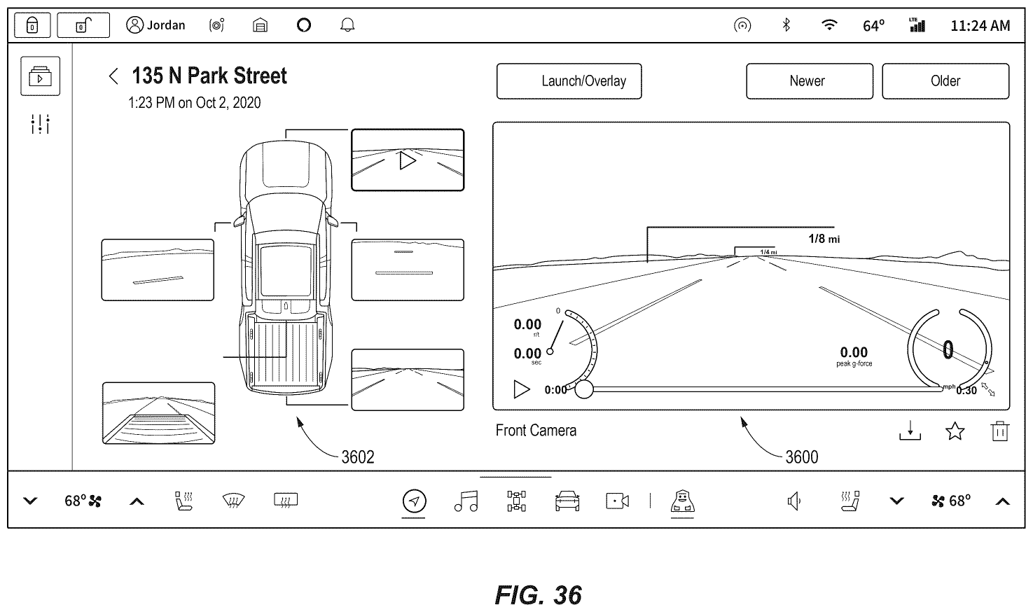

Referring to FIG. 36, there may be multiple exterior cameras 102, all of which may capture video before and after a run as described above. The illustrated interface may be displayed on the center display. The interface may include a first area 3600 in which video from a selected exterior cameras (or possibly an interior camera) is displayed, possibly with information superimposed thereon as described above. The interface may include a region 3602 including representations of the outputs of other non-selected exterior cameras. The region 3602 may include a representation of the vehicle 100 with lines indicating where an exterior camera used to capture video is located. A user may select the representations of the outputs of a non-selected camera in the region 3602 to invoke moving the output of the non-selected camera to the area 3600.

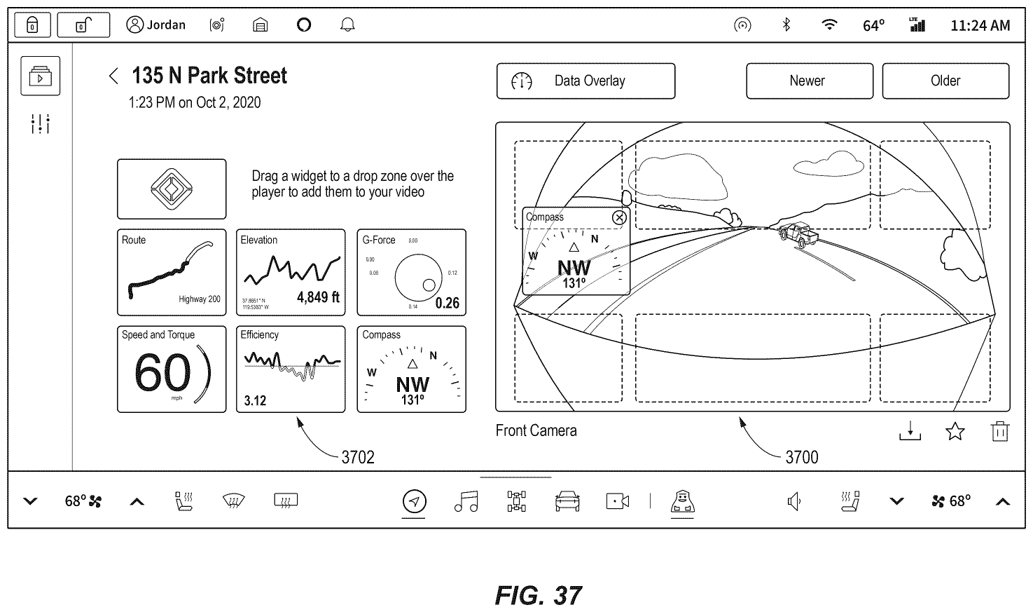

Referring to FIG. 37, in some embodiments, a user may select what information is superimposed over video of a launch. For example, an interface for customizing displayed information may include a region 3700 showing information that is selected for display and where the information is to be displayed. The region 3700 may further indicate possible placement locations for superimposed information. Interface elements 3702 may be placed in the region 3700 in order to add display of information represented by the interface element to a placement location within the region 3700.

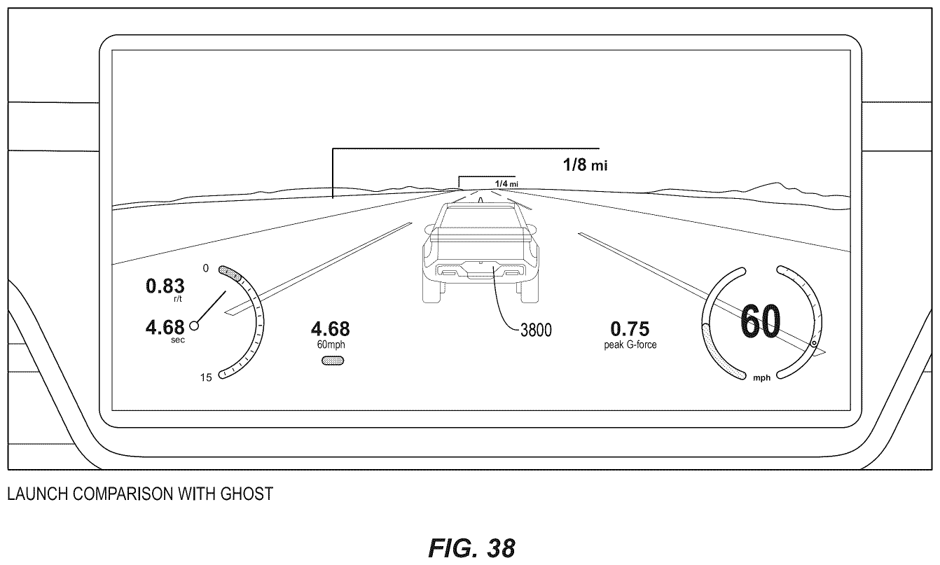

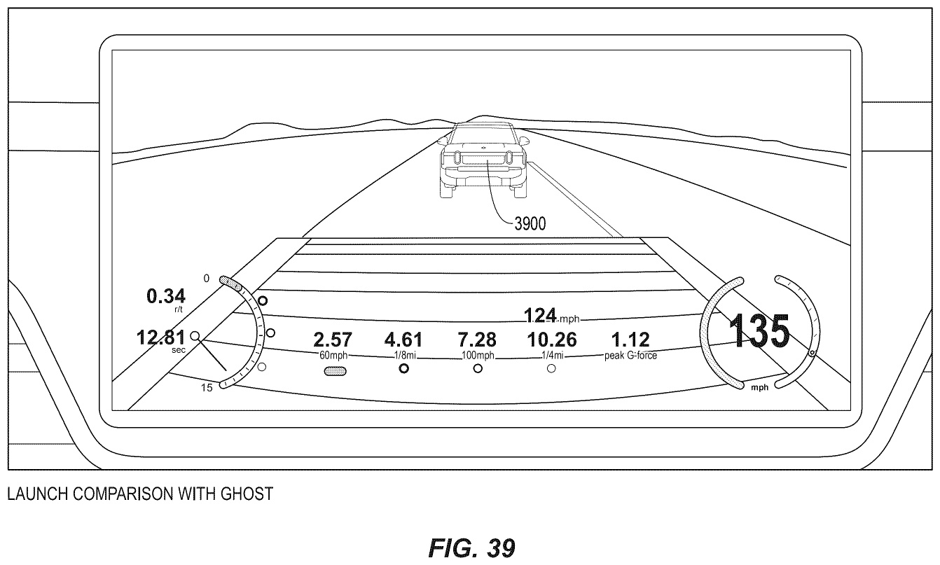

Referring to FIGS. 38 and 39, display of video for a run according to any of the embodiments disclosed herein may include a comparison to a previous run. For example, a translucent, transparent, or wire-frame representation 3800 of the vehicle may be superimposed in frames of video at a location corresponding to the location of the vehicle in a previous run. FIG. 38 indicates that the vehicle 100 was faster in a previous run and the representation 3800 is shown in video captured with a forward-facing external camera 102. FIG. 39 indicates that the vehicle 100 was slower in a previous run and the representation 3900 is shown in video captured with a rearward-facing external camera 102.

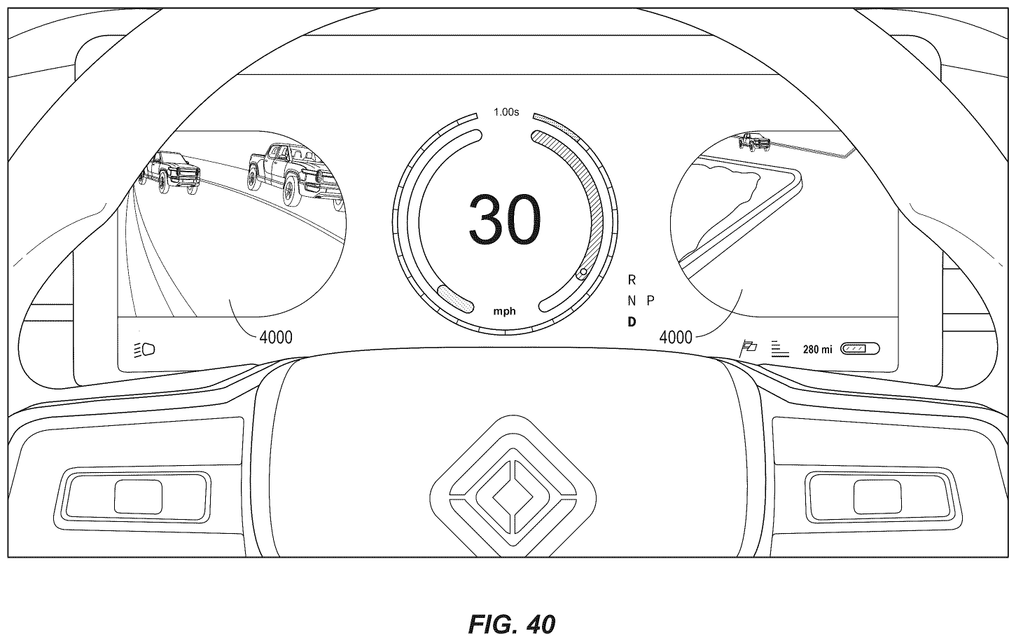

As shown in FIG. 40, an interface according to any of FIGS. 11-26 may be augmented with display of the output of one or more exterior cameras 102. For example, images 4000 from blind-spot monitoring cameras may be output on either side of interface elements of any of the interfaces of FIGS. 11-26. The images 4000 may increase awareness of competitors or people or objects on either side of the vehicle 100 during a run.

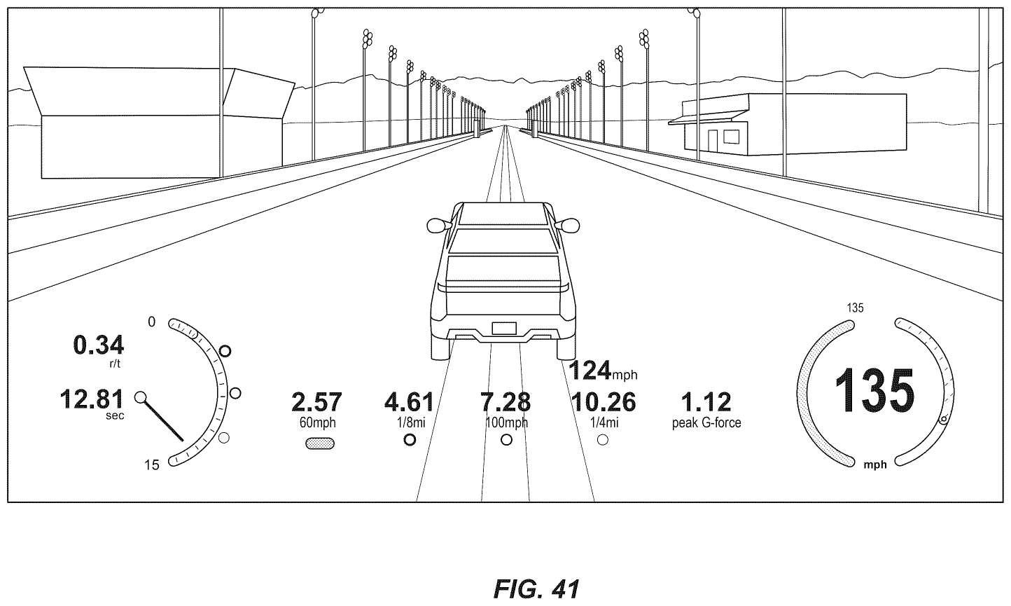

Referring to FIG. 41, data collected during a run may be used to create a rendered video. An animation of the vehicle 100 traversing a famous race track or other setting may be rendered with the speed of the vehicle and superimposed information corresponding to data captured during a run. The superimposed information may include any of the information described with respect to FIGS. 28-40.

Data collected during a run may be transmitted to a mobile device of a user, such as by way of a central server. Data collected during a run may be collected and stored by the control system 206 such that a user may browse and display the results of previous runs. The data that is stored and available for display may include video of a run, such as with superimposed information as shown in FIGS. 28-32, 34A-39. Statistics may also be displayed in tabular form. Example statistics may include a location, a vehicle state (e.g., state of charge), zero to 60 time, zero to 100 time, 60 feet time, 330 feet time, eighth mile time, quarter mile time, top speed, peak g-force, reaction time, energy (kWh) used, or other information. Data for runs may be arranged in a list in which labels (e.g., location names) for a run may be selected to display data for the run. Data for runs may be ordered by data or other criteria, e.g., fastest quarter mile time, highest top speed, or the like.

The descriptions of the various embodiments of the present disclosure have been presented for purposes of illustration. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure may exceed the specific described embodiments. Instead, any combination of the features and elements, whether related to different embodiments, is contemplated to implement and practice contemplated embodiments. Furthermore, although embodiments disclosed herein may achieve advantages over other possible solutions or over the prior art, the embodiments may achieve some advantages or no particular advantage. Thus, the aspects, features, embodiments and advantages discussed herein are merely illustrative.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a one or more computer processing devices. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Certain types of storage devices that include these mediums include: diskette, hard disk, random access memory (RAM), read only memory (ROM), erasable programmable read only memory (EPROM or Flash memory), static random access memory (SRAM), compact disc read only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, refers to non-transitory storage rather than transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but the storage device remains non-transitory during these processes because the data remains non-transitory while stored.

While the foregoing is directed to embodiments of the present disclosure, other and further embodiments may be devised without departing from the basic scope thereof, and the scope thereof is determined by the claims that follow.

What is claimed is:

1. A vehicle comprising:
a chassis;
a plurality of suspensions mounted to the chassis;
a plurality of wheels mounted to the plurality of suspensions;
a battery mounted to the chassis;
one or more drive units, each drive unit configured to drive one or more of the plurality of wheels using drive current supplied by the battery;
a display device; and
a controller coupled to the battery, the one or more drive units, and the display device, the controller configured to:
receive one or more inputs instructing a transition to a launch mode; and
in response to the one or more inputs:
invoke, by the controller, transitioning of one or more components of the vehicle to enable a launch of the vehicle, the one or more components including at least one of the battery, the one or more drive units, or the plurality of suspensions;
provide an output on the display device, the output graphically representing a state of a driver-controllable component of the vehicle; and
enable launching of the vehicle according to the launch mode in response to a state of the driver-controllable component being in a predefined configuration and completion of the transitioning of the one or more components.

2. The vehicle of claim 1, wherein:
the driver-controllable component is steered wheels of the plurality of wheels; and
the predefined configuration is a steering angle of the steered wheels being within a threshold angle of straight.

3. The vehicle of claim 2, wherein the output is a graphical representation of a steering wheel coupled to the steered wheels, an angle of the graphical representation corresponding to the steering angle.

4. The vehicle of claim 2, wherein the output is an arc, and a size and position of a gap defined by the arc correspond to the steering angle.

5. The vehicle of claim 4, wherein the controller is configured to render a complete circle in place of the arc in response to the steering angle of steered wheels being within the threshold angle of straight.

6. The vehicle of claim 1, wherein:
the driver-controllable component is a brake pedal; and
the predefined configuration is the brake pedal being depressed at least to a predetermined position.

7. The vehicle of claim 6, wherein the output is an arc, a size of a gap defined by the arc corresponding to a difference between a current position of the brake pedal and the brake pedal being depressed to at least the predetermined position.

8. The vehicle of claim 7, wherein the controller is configured to render a complete circle in place of the arc in response to the brake pedal being depressed to at least the predetermined position.

9. The vehicle of claim 6, wherein the controller is configured to launch the vehicle in response to release of the brake pedal.

10. The vehicle of claim 1, wherein:
the driver-controllable component is an accelerator pedal; and
the predefined configuration is the accelerator pedal being depressed at least to a predetermined position.

11. The vehicle of claim 10, wherein the output is an arc, and a size of a gap defined by the arc corresponds to a difference between a current position of the accelerator pedal and the accelerator pedal being depressed to at least the predetermined position.

12. The vehicle of claim 11, wherein the controller is configured to render a complete circle in place of the arc in response to the accelerator pedal being depressed to at least the predetermined position.

13. The vehicle of claim 1, wherein the one or more components include both of the battery and the plurality of suspensions.

14. The vehicle of claim 1, wherein the controller is configured to adjust one or more limits in response to the one or more inputs, the one or more limits including at least one of:
a torque limit for the one or more drive units;
a current limit for the one or more drive units;
a current limit for the battery;
a temperature limit for the one or more drive units; and
a temperature limit for the battery.

15. The vehicle of claim 1, wherein the display device is a touch screen, and the one or more inputs comprise:
a first input to the touch screen, the first input selecting the transition to the launch mode; and
a second input to the touch screen, the second input confirming selection of the transition to the launch mode.

16. The vehicle of claim 15, wherein the second input is a gesture other than tapping a portion of the touch screen.

17. The vehicle of claim 1, wherein the controller is configured to commence recording video from one or more exterior cameras in response to the one or more inputs.

18. The vehicle of claim 1, wherein the controller is configured to output a countdown in response to the one or more inputs.

19. A method comprising:
receiving, by a controller of a vehicle, one or more inputs instructing a transition to a launch mode; and
in response to the one or more inputs, performing, via the controller:
invoking transitioning of one or more components of the vehicle to enable a launch of the vehicle, the one or more components including at least one of a battery, one or more drive units, or a plurality of suspensions;
providing an output on a display device of the vehicle, the output graphically representing a state of a driver-controllable component of the vehicle; and
enabling launching of the vehicle according to the launch mode in response to a state of the driver-controllable component being in a predefined configuration and completion of the transitioning of the one or more components.

20. The method of claim 19, wherein the driver-controllable component is at least one of steered wheels of a plurality of wheels of the vehicle, a brake pedal, and an accelerator pedal.
